(19) United States
(12) Patent Application Publication
(10) Pub. No.: US 2009/0308753 A1
(43) Pub. Date: Dec. 17, 2009

(54) Methods for controlling silica deposition onto carbon nanotube surfaces

(76) Inventors: Stanislaus S. Wong, Stony Brook, NY (US); Mandakini Kanungo, Webster, NY (US)

Correspondence Address: HOFFMANN & BARON, LLP, 6900 JERICHO TURNPIKE, SYOSSET, NY, 11791, US

(21) Appl. No.: 12/386,762

(22) Filed: Apr. 21, 2009

Related U.S. Application Data
(60) Provisional application No. 61/125,061, filed on Apr. 21, 2008.

(51) Int. Cl. B32B 9/00; C25D 21/12; C25D 7/04; B82B 1/00; B82B 3/00

(52) U.S. Cl. 205/50; 205/83; 977/742; 977/847

(57) ABSTRACT

The invention provides a method of controlling the rate of noncovalent silica deposition onto at least one carbon nanotube. The method comprises (a) providing a one chamber electrochemical cell comprising a working electrode comprising at least one carbon nanotube; a reference electrode; a counter electrode; supporting electrolytes; and a reagent solution, wherein the reagent solution comprises a precursor of silica; and (b) applying a selected negative potential to the working electrode, wherein the rate of silica deposition onto the at least one carbon nanotube increases as the potential becomes more negative.

### CROSS-RELATED APPLICATION

This application claims benefit from U.S. provisional Application Ser. No. 61/125,061, filed on Apr. 21, 2008, which application is incorporated herein by reference in its entirety.

This invention was made with Government support from the National Science Foundation under Grant No. DMR-0348239 and U.S. Department of Energy Office of Basic Energy Sciences under contract DE-AC02-98CH 10886. The Government has certain rights in this invention.

### BACKGROUND OF THE INVENTION

The remarkable structure-dependent optical, electronic, and mechanical properties of single-walled carbon nanotubes (SWNTs) have attracted a lot of attention over the last decade due to their potential in applications as varied as molecular electronics, sensing, gas storage, field emission applications, catalyst supports, probes for scanning probe microscopy, and components in high-performance composites (Iijima, S., Nature, 1991, 354-56; Dresselhaus et al., Carbon Nanotubes: Synthesis, Structure, Properties, and Applications, Springer Verlag: Berlin, 2001; Baughman et al., Science, 2002, 297-787; Avouris, P., Acc. Chem. Res., 2002, 35, 1026). Chemical functionalization has been used as a route towards rationally tailoring the properties of carbon nanotubes so they can be incorporated into functional devices and architectures (Bahr et al., J. Mater. Chem, 2002, 12, 1952; Hirsch, A., Angew. Chem. Intl. Ed., 2002, 41, 1853; Chen et al., Science, 1998, 282, 95; Banerjee et al., Adv. Mater., 2005, 17, 17). One of the particularly promising and as yet relatively unexplored areas of research involves coating of SWNTs with insulating materials to fabricate nanotube-based devices such as field effect transistors (FETs), single-electron transistors, and gas sensors (Wind et al., Appl. Phys. Lett, 2002, 80, 3817; Postma et al., Science, 2001, 293, 76; Kong et al., Science, 2000, 287, 622)

In general, the synthesis of a carbon nanotube-insulator heterostructure is important for the use of carbon nanotubes in applications ranging from FET devices to molecular circuits and switches. Specifically, carbon nanotube-silica heterostructure composites are particularly intriguing because of the well-known insulating properties of silica. Indeed, carbon nanotube-silica composites are often critical for applications ranging from electronics, optics, to biology. A protective coating of silica can limit the perturbation of the desirable mechanical and electronic properties of nanotubes, while simultaneously providing for a means to functionalize these nanoscale species. In addition, a thin SiO₂/SiOₓ coating is optically transparent and moreover, silica is well known for its biomolecular compatibility. Furthermore, it is envisaged that the coating of thin, transparent silica on carbon nanotube surfaces would enable their utilization in applications associated with biomedical optics.

Two general strategies have been utilized for silica functionalization of carbon nanotubes. One involves covalent functionalization of silica onto carbon nanotube sidewalls using a range of either silyl or silane derivatives (Bottini et al., Chem. Commun., 2005, 6, 758; Vast et al., Nanotechnology, 2004, 15, 781; Velasco-Santos et al., Nanotechnology, 2002, 13, 495; Aizawa et al., Chem. Phys. Lett., 2003, 368, 121; Fan et al., Chem. Lett., 2005, 34, 954). Though covalent functionalization is a robust and a well-controlled process, it may also seriously compromise or otherwise destroy the desirable electronic and optical properties of the carbon nanotubes to a large extent. An alternative strategy has been to coat carbon nanotubes with silica using a noncovalent methodology. A recent theoretical study has shown that a non-bonded, protective layer of silica only weakly perturbs the electronic structure of single walled carbon nanotubes (SWNTs) (Wojdel et al., J. Phys. Chem. B., 2005, 109, 1387). Therefore, for optimal performance, the existence of a protective layer of silica on the carbon nanotubes should not only enable the retention of desirable electronic, mechanical and optical properties of carbon nanotubes but also simultaneously and non-destructively functionalize these nanoscale species for a number of diverse applications.

Experimentally, multi-walled carbon nanotubes (MWNTs) coated with silica at room temperature reveal a higher oxidation resistance and better mechanical properties when compared with heavily processed tubes (Seeger et al., Chem. Commun., 2002, 1, 34). An increase in thermal conductivity has been reported for homogeneous MWNT-SiO₂ composites, while MWNT/silica xerogel composites have been shown to display enhanced nonlinear optical properties, relative to those of underivatized MWNTs (Ning et al., J. Mater. Sci. Lett., 2003, 22, 1019; Hongbing et al., Chem. Phys. Lett., 2005, 411, 373). In addition, MWNT-sol gel composite materials, depending on the nature of the silane precursors used in their fabrication, have been reported to show faster electron transfer rates and a wide range of favorable capacitance values, thereby providing for enhanced capabilities in the development of novel electrochemical devices using these composites (Gavalas et al., Nano Lett., 2001, 1, 719). However, control over the thickness of such a silica coating is contentious but highly desirable. As mentioned, a thin, transparent, biocompatible coating of silica on carbon nanotube surfaces would increase their utilization in optics and in biomedical devices (Coradin et al., ChemBioChem, 2003, 4, 251). Moreover, a silica coating onto the carbon nanotubes would also aid in avoiding tube-tube contact and bundle formation as well as tube oxidation, a scenario conducive to the use of appropriately functionalized carbon nanotubes as individualized gate dielectric materials in field effect transistors (Wind et al., Appl. Phys. Lett, 2002, 80, 3817).

There have been several reports regarding the coating of silica onto both multi-walled nanotubes (MWNTs) and single walled nanotubes (SWNTs) by various methods. Silica coated MWNTs have been prepared using a pulsed laser deposition method wherein the thickness of the layer was varied between 2 to 28 nm (Ikuno et al., Jpn. J. Appl. Phys., 2003, 42, L1356; Ikuno et al., Jpn. J. Appl. Phys., 2004, 7B, L987). SWNTs have been coated with a thin layer of SiO₂ (1 nm) using 3-aminopropyltriethoxysilane as a coupling agent (Fu et al., Nano Lett., 2002, 2, 329). SWNTs have been derivatized with a fluorine-doped silica layer through a liquid phase deposition (LPD) process using a silica-H₂SiF₆ solution and a surfactant-stabilized solution of SWNTs (Whitsitt et al., Nano. Lett., 2003, 3, 775; Whitsitt et al., J. Mater. Chem., 2005, 15, 4678). In these experiments, Raman, fluorescence, and UV-visible-near-IR studies of silica coated nanotubes suggested the lack of covalent sidewall functionalization occurring on the tubes during the coating process and that importantly, this implied that the coating did not interfere with the electrical properties of the nanotubes. Hollow silica-coated SWNTs and SWNT-silica composite hex nuts have also been synthesized in basic conditions using aqueous sodium silicate (Colorado et al., J. Mater. Chem., 2004, 16, 2692; Colorado et al., Adv. Mater., 2005, 17, 1634). Recently, a peptide-mediated route has been reported towards the generation of a silica-SWNT composite in which a multifunctional peptide was initially used to coat, disperse, and suspend SWNTs; this identical peptide was also used to mediate the precipitation of silica and titania onto the carbon nanotube surfaces (Pender et al., Nano Lett., 2006, 6, 40).

In addition to the above-mentioned techniques, the sol-gel method in particular has been extensively used for the preparation of carbon nanotube-silica composites (Seeger et al., Chem. Commun., 2002, 1, 34; Ning et al., J. Mater. Sci. Lett., 2003, 22, 1019; Hongbing et al., Chem. Phys. Lett., 2005, 411, 373; Gavalas et al., Nano Lett., 2001, 1, 719; Berguiga et al., Opt. Mater., 2006, 28, 167; Liu et al., Carbon, 2006, 44, 158). The sol-gel technique is well known in the fabrication of new material composites because of its advantages over conventional processing methodologies, especially for glass-like materials. In the sol-gel process, metal oxide precursors are mixed in the presence of water, alcohol, and either a base or acid catalyst. The molecular-scale reaction tends to form multi-component materials at much lower temperatures than are normally associated with traditional processing methods. Though a sol-gel process combined with a sintering technique at high temperatures has been developed to yield a SiOₓ coating on MWNTs, the same group also reported a room-temperature variation of this protocol, based on the initial creation of positive charges on the MWNT surface by polyelectrolyte adsorption and subsequent deposition of negatively charged SiOₓ through a condensation reaction involving tetraethoxysilane (TEOS) in water (Seeger et al., Chem. Commun., 2002, 1, 34; Seeger et al., Chem. Phys. Lett., 2001, 339, 41). A different research team reported a sol-gel method of creating a silica coating on MWNTs, using THF, sodium methoxide and 3-mercaptopropyltrimethoxysilane (Berguiga et al., Opt. Mater., 2006, 28, 167).

Though all of these reports have successfully prepared silica coatings on carbon nanotubes, the fundamental problem of actually fine tuning the thickness of silica on carbon nanotubes remains unresolved. Moreover, published experimental conditions for silica deposition tend to involve the use of harshly acidic or basic conditions, usually necessitate long periods of reaction time, often require a multistep synthesis procedure with the formation of byproducts, and ultimately, provide for little if any control over the thickness of the as-generated silica coating. In fact, pulsed laser deposition is the only reported method for the quantitative variation of silica thickness of silica with deposition time, but the main disadvantage of this technique is that it requires sophisticated, expensive instrumentation, and lacks the versatility and flexibility of a solution phase-inspired protocol.

Control over the thickness of a silica coating on single-walled carbon nanotubes (SWNTs) is highly desirable for applications in optics and in biomedicine. Moreover, a silica coating on SWNTs would also aid in avoiding tube-tube contact and bundle formation as well as tube oxidation, a scenario conducive to the use of appropriately functionalized carbon nanotubes as individualized gate dielectric materials in field effect transistors.

### SUMMARY OF THE INVENTION

The present invention relates to methods of controlling the rate of noncovalent silica deposition onto carbon nanotubes. The present invention also includes the resulting carbon nanotubes.

In one embodiment, a one chamber electrochemical cell is provided. The electrochemical cell includes a working electrode comprising at least one carbon nanotube; a reference electrode; a counter electrode; supporting electrolytes; and a reagent solution. The reagent solution comprises a precursor of silica. A selected negative potential is applied to the working electrode with respect to the reference electrode. The rate of silica deposition onto the carbon nanotube increases as the potential becomes more negative.

The potential of the working electrode is varied in the range of from about −300 mV to about −1000 mV as compared to the reference electrode.

Examples of the working electrode include a SWNT mat or MWNT mat, a single SWNT or single MWNT, a plurality of individualized SWNTs or a plurality of individualized MWNTs, and combinations thereof.

Examples of the reference electrode include a silver/silver salt wire or a Saturated Calomel Electrode (SCE). Examples of silver/silver salt wires include an Ag/AgCl wire, Ag/AgNO₃ wire and an Ag/Ag₂SO₄ wire.

Examples of counter electrodes include a platinum (Pt) electrode or a glassy carbon electrode.

Examples of precursors of silica include tetramethoxysilane (TMOS), tetraethylorthosilicate or methyltrimethoxysilane (MTMOS). Further examples of precursors of silica include {2-[2-(2-methoxyethoxy)ethoxy]ethoxy}trimethylsilane, bis{2-[2-(2-methoxyethoxy)ethoxy]ethoxy}dimethylsilane, {3-[2-(2-(2-methoxyethoxy)ethoxy)ethoxy]-propyl}trimethylsilane, {[2-(2-(2-methoxyethoxy)ethoxy)ethoxy]-methyl}trimethyl silane. 3-(Glycidoxypropyl)trimethoxysilane (GPTMS), N-(2-aminoethyl)-3-aminopropyl-trimethoxysilane, or dimethyldichlorosilane.

The method can further comprise controlling the rate of noncovalent silica deposition by varying the concentration of the precursor of silica, wherein as the precursor of silica concentration is increased, the rate increases.

The method can further comprise stirring the reagent solution whereby the degree of uniformity of silica deposition is increased.

The method can further comprise immersing the carbon nanotube mat (e.g., SWNT mat) in an aqueous solvent after silica deposition to debundle carbon nanotubes (e.g., SWNTs) from the mat.

In another embodiment, the invention includes a carbon nanotube(s) with a noncovalently attached silica coating formed by a method comprising providing a one chamber electrochemical cell including a working electrode comprising at least one carbon nanotube; a reference electrode; a counter electrode; supporting electrolytes; and a reagent solution, wherein the reagent solution comprises a precursor of silica; and applying a selected negative potential to the working electrode, wherein the rate of silica deposition onto the carbon nanotube(s) increases as the potential becomes more negative.

In a further embodiment, the invention includes silylating carbon nanotube(s) by placing a sonicated nanotube dispersion and a working electrode into a silica precursor sol. The sol comprises an electrolyte placed in an aqueous solution of a silica precursor. Preferred examples of the silica precursors are as described above. A selected negative potential is applied to the working electrode, wherein the rate of silica deposition onto the nanotubes in the dispersion increases as the potential becomes more negative.

Preferred examples of the working electrode include Pt, indium-tin-oxide (ITO) and a glassy carbon electrode. The potential of the working electrode is preferably varied in the range of from about −700 mV to about −1000 mV.

The method can optionally further comprise controlling the rate of noncovalent silica deposition by varying the concentration of the silica precursor, wherein as the silica precursor concentration is increased, the rate increases. The method can optionally further comprise stirring the reagent solution whereby the degree of uniformity of silica deposition is increased.

In an additional embodiment, the invention provides carbon nanotube(s) with a noncovalently attached silica coating formed by the method comprising placing a sonicated nanotube dispersion and a working electrode into a silica precursor sol; and applying a selected negative potential to the working electrode, wherein the rate of silica deposition onto the nanotubes in the dispersion increases as the potential becomes more negative, wherein the sol comprises an electrolyte placed in an aqueous solution of silica precursor.

The methods of the present invention have several advantages over prior art methods. For example, the silica is coated on the nanotubes in a noncovalent and therefore nondestructive fashion. Additionally, the methods are fairly mild and environmentally friendly in that these methods require a minimum amount of reactants and conditions that are neither harshly acidic nor basic conditions. Also, the actual reaction time needed for electrodeposition is only about 5 to 10 min, as compared with the much longer reaction times associated with prior art methods. Moreover, the methods of the present invention can be carried out at room temperature under ambient conditions. Furthermore, the invention provides the first controllable methodology aimed at the fine tuning of the silica film thickness on carbon nanotube surfaces through a solution phase methodology involving a rational and systematic variation of reaction parameters.

### BRIEF DESCRIPTION OF THE DRAWINGS

FIG. 1. (a) A cyclic voltammogram of a SWNT mat electrode obtained at a scan rate of 10 mV/sec. (b) A representative chronoamperometric curve of a SWNT mat electrode in a TMOS sol, showing the response to a potential step from 0 to −700 mV.

FIG. 2. (a). Cyclic voltammogram of a Pt electrode in the presence of a TMOS sol at a scan rate of 10 mV/sec. (b) A representative chronoamperometric response of SWNT ‘electrodes’ dispersed in TMOS sol, illustrating the response to a potential step from 0 to −700 mV.

FIG. 3. AFM height images of silica-coated carbon nanotubes synthesized by electrochemical silylation using a SWNT mat electrode (Si-SWNT-1) at −500 mV, −800 mV and −1000 mV (a-c) respectively. The z scale is 100 nm for FIGS. 3a and 3b and 300 nm for 3c, respectively. The scale bar represents 250 nm, 200 nm, and 250 nm for FIG. 3a, 3b, and 3c, respectively. FIG. 3d represents the plot of the height of silica-coated SWNTs (Si-SWNT-1) vs. applied potential at an open circuit potential of 0, −500, −600, −700, −800, −900 and −1000 mV respectively. FIG. 3e shows the corresponding plot of thickness of the silica film at these various potentials. Letters ‘U’ and ‘C’ denote the relatively uncoated and heavily coated parts of the nanotube bundles, respectively.

FIGS. 4(a-c). AFM height images of silica-coated nanotubes synthesized by electrochemical deposition onto carbon nanotubes dispersed in solution (Si-SWNT-2) at potentials of −800, −900, and −1000 mV respectively. The z data scale is 100 nm for 4a and 4b and 300 nm for 4c. The scale bars for FIG. 4a, 4b, and 4c are 250 nm, 250 nm, and 200 nm, respectively. FIGS. 4(d) and (e) represent AFM heights and thicknesses of electrodeposited silica film (Si-SWNT-2) at the negative applied potentials of 0, −700 mV, −800 mV, −900 mV and −1000 mV, respectively. FIGS. 4(f) and (g) show the increase in heights and thicknesses (as measured by AFM) of silica-coated nanotubes (Si-SWNT-2) probed as a function of silica concentration in solution (7.4·10⁻⁵ M, 1.49·10⁻⁴ M, 2.92·10⁻⁴ M, 4.28·10⁻⁴ M, and 5.6·10⁻⁴ M, respectively). Letters ‘U’ and ‘C’ denote the relatively uncoated and heavily coated parts of the nanotube bundles, respectively.

FIG. 5. SEM images and corresponding EDS spectra (d-f) of (a) silica-coated carbon nanotubes prepared from a carbon nanotube mat electrode (Si-SWNT-1) and of (b) nanotubes, electrodeposited with silica, from solution (Si-SWNT-2). (c) Purified, air-oxidized SWNTs. The scale bar is 100 nm.

FIG. 6. (a) HRTEM image of purified tubes. (b) HRTEM image of Si-SWNT-1 electrodeposited at −600 mV (c) HRTEM image of Si-SWNT-2 electrodeposited at −700 mV. Scale bars for (a)-(c) are 5 nm, 10 nm and 10 nm respectively. FIGS. 6d through f shows the EDS spectra of purified tubes, Si-SWNT-1 and Si-SWNT-2 tubes respectively.

FIG. 7. Purified SWNTs (red). Si-SWNT-1 electrodeposited at −1000 mV (blue); Si-SWNT-2 electrodeposited at −1000 mV (green); and pristine samples (purple). (a) UV-visible spectra. (b) FT-mid IR spectra. (c) FT-near IR spectra of nanotube samples.

FIG. 8. Raman spectra (RBM region) of pristine HiPco SWNTs (purple), air oxidized nanotubes (red), Si-SWNT-1 (blue), Si-SWNT-2 (green) and Si-SWNT-crtl-1 (black). (a) Excitation at 780 nm with normalization with respect to RBM feature at 394 cm⁻¹, (b) Excitation at 514.5 nm wavelength with normalization with respect to 231 cm⁻¹ (c) Excitation at 632.8 nm wavelength with normalization with respect to the RBM feature at 164 cm⁻¹.

FIG. 9. Raman spectra of tangential and disorder mode regions of pristine HiPco SWNTs (purple), purified air oxidized nanotubes (red), Si-SWNT (blue), Si-SWNT-2 (green), and Si-SWNT-ctrl-1 (black). Excitation at (a) 780 nm, (b) 632 nm, and (c) 514.5 nm wavelengths, respectively. Spectra were normalized with respect to the G⁺ feature.

### DETAILED DESCRIPTION OF THE INVENTION

The present invention relates to the field of nanotechnology, including nanostructures and their applications.

The present invention includes methods for controlling the rate of silica deposition onto carbon nanotubes. Also, included in the present invention are the resulting silica-coated carbon nanotubes.

A carbon nanotube of the present invention is a graphene sheet in cylindrical form. The sidewall of a carbon nanotube is the outer surface of the graphene sheet. The ends of a nanotube can be open, or can have hemispherical caps on one or both ends. A carbon nanotube can be a semi-conducting nanotube or a metallic nanotube.

A carbon nanotube of the present invention is either a single-walled nanotube (SWNT) or a multi-walled nanotube (MWNT). A SWNT comprises only one nanotube. A MWNT comprises more than one nanotube each having a different diameter. Thus, the smallest diameter nanotube is encapsulated by a larger diameter nanotube, which in turn, is encapsulated by another larger diameter nanotube. An example of a MWNT is a double-walled nanotube. A MWNT can comprise typically up to about fifty nanotubes.

SWNTs typically have a diameter of about 0.7 to about 2.5 nm, and a length of up to about one mm. MWNTs typically have a diameter of about 3 to about 30 nm, and a length of up to about one mm.

The carbon nanotubes can also be in a bundle. A carbon nanotube bundle of the present invention comprises a plurality of SWNTs or MWNTs. The diameter of a bundle of SWNTs is typically about 1 to 20 nm. The diameter of a bundle of MWNTs is typically about 2.5 to 250 nm.

The carbon nanotubes of the present invention are coated with silica in a noncovalent fashion. The favorable electronic and optical properties of the nanotubes are retained after coating the nanotubes with silica.

In one embodiment of the present invention, an electrochemical cell is utilized in a method of controlling the rate of noncovalent silica deposition onto a carbon nanotube.

Typically, an electrochemical cell has a counter electrode at the top of the cell, a non-current-carrying reference electrode positioned in the central region of the cell and a working electrode positioned near the bottom of the cell. Controlling and measuring the electrical parameters of an electrode reaction is done by potential, current and charge control means. The two most common modes of operation are potential control or potentiostatic mode and the current control or galvanostatic mode. A review article by R. Greef, covering this subject matter is published in Journal of Physics E, Scientific Instruments, Vol. 11, 1978, pages 1-12 (printed in Great Britain).

In the method of the invention, a one chamber electrochemical cell is provided. The electrochemical cell comprises a working electrode, a reference electrode, a counter electrode, supporting electrolytes and a reagent solution.

The working electrode comprises at least one carbon nanotube. Examples of suitable working electrodes include the carbon nanotubes described above. Preferred examples are SWNT mats, a single SWNT and a plurality of individualized SWNTs.

Examples of reference electrodes are silver/silver salt wires and a Saturated Calomel Electrode (SCE). Examples of silver/silver salt wires include Ag/AgCl wire, Ag/AgNO₃ wire and Ag/Ag₂SO₄ wire. Further examples of reference electrodes can be found at the following site: http://www.nico2000.net/Book/Guide6.html

The counter electrode is necessary to complete the circuit in the electrochemical cell. Examples of counter electrodes include platinum (Pt) electrode or a glassy carbon electrode.

The reagent solution comprises a precursor of silica. Preferred examples of precursors of silica include tetramethoxysilane (TMOS), tetraethylorthosilicate (or equivalently, tetraethoxysilane and TEOS) and methyltrimethoxysilane (MTMOS). TMOS is most preferred because it produces uniform films.

Other examples of precursors of silica include {2-[2-(2-methoxyethoxy)-ethoxy]ethoxy}trimethylsilane, bis{2-[2-(2-methoxyethoxy)ethoxy]ethoxy}-dimethylsilane, {3-[2-(2-(2-methoxyethoxy)ethoxy)ethoxy]-propyl}trimethylsilane, {[2-(2-(2-methoxyethoxy)ethoxy)ethoxy]-methyl}trimethylsilane, 3-(Glycidoxypropyl)trimethoxysilane (GPTMS), N-(2-aminoethyl)-3-aminopropyl-trimethoxysilane, and dimethyldichlorosilane.

The role of the supporting electrolytes is to increase the solution conductivity, while not taking part in the reaction. If the reference electrode comprises chloride then the electrolyte is a chloride salt. Examples of suitable electrolytes include KCl, NaCl, and sodium perchlorate. If the reference electrode comprises a nitrate or sulfate then the electrolyte is a nitrate salt or sulfate salt, respectively, e.g., salts of sodium, potassium and lithium. Bromides and iodides can be used also.

Electrodeposition can be carried out by either potentiostatic (constant potential) or galvanostatic (constant current) or by potential sweep method. The potential sweep method involves observations of the current as a function of the potential while the latter is varied at a constant known rate. The film morphology depends on the type of electrodeposition.

For example, a selected negative potential is applied to the working electrode. The potential of the working electrode is measured with respect to the reference electrode. In order for silica to be deposited on the working electrode, the potential at the working electrode must be less (i.e., more negative) than its oxygen reduction peak. For a carbon nanotube, the oxygen reduction peak is about −300 mV. Thus, for example, the potential of the working electrode can be varied in the range of about −200 mV to about −300 mV, of about −1000 mV to about −300 mV, preferably of about −1000 mV to about −500 mV, as compared to the reference electrode. (Also, in another aspect, the potential of the working electrode can be varied in the range of about −20mV to about −2000 mV, as compared to the reference electrode.)

The rate of silica deposition onto the carbon nanotube(s) increases as the potential becomes more negative. That is, the rate of deposition onto the carbon nanotube(s) is greater at more negative potentials. Also, increasing the current increases the rate of silica deposition. For example, the current can be varied in the range of about 0.1 Amperes to about 10 Amperes.

Additionally, the rate of silica deposition can be controlled by varying the concentration of the precursor of silica, wherein as the precursor of silica concentration is increased, the rate increases.

Further, the degree of uniformity of silica deposition can be increased by stirring the reagent solution.

After silica deposition onto a carbon nanotube mat (e.g., a SWNT mat), the carbon nanotube mat is preferably immersed in an aqueous solvent to debundle the carbon nanotubes from the mat. The carbon nanotubes in the aqueous solvent are preferably sonicated. The carbon nanotubes can then be filtered and centrifugated to remove the excess silica.

In another embodiment of the present invention, a silica precursor sol is utilized in a method of controlling the rate of noncovalent silica deposition onto carbon nanotube(s).

The method comprises placing a sonicated nanotube dispersion and a working electrode into a silica precursor sol. The sol comprises an electrolyte placed in an aqueous solution of a silica precursor. Examples of silica precursors are described above. A preferred silica precursor is TMOS sol. Examples of electrolytes are described above.

Examples of suitable working electrodes include Pt, indium-tin-oxide (ITO) and a glassy carbon electrode. Examples of reference and counter electrodes are as described above. Preferably, the counter electrode is Pt foil, and the reference electrode is Ag/AgCl.

A selected negative potential is applied to the working electrode measured with respect to the reference electrode. In order for the silica to be deposited on the nanotubes in the dispersion, the potential at the working Pt electrode must be less (i.e., more negative) than its oxygen reduction peak. For a Pt electrode, the oxygen reduction peak is about −500 mV. Thus, for example, the potential of the working electrode can be varied in the range of about −1200 mV to about −500 mV, preferably in the range of about −1000 mV to about −700 mV, as compared to the reference electrode. (Also, in another aspect, the potential of the working electrode can be varied in the range of about −20 mV to about −2000 mV, as compared to the reference electrode.)

The rate of silica deposition onto the nanotubes in the dispersion increases as the potential at the working electrode becomes more negative. Also increasing the current increases the rate of silica deposition. For example, the current can be varied in the range of about 0.1 Amperes to about 10 Amperes.

The rate of noncovalent silica deposition can also be controlled by varying the concentration of the silica precursor, wherein as the precursor concentration is increased, the rate increases.

Also, the degree of uniformity of silica deposition can be increased by stirring the reagent solution.

Thus, while there have been described the preferred embodiments of the present invention, those skilled in the art will realize that other embodiments can be made without departing from the spirit of the invention, and it is intended to include all such further modifications and changes as come within the true scope of the disclosure set forth herein.

### EXAMPLES

The present invention provides feasible and reliable means with which to coat SWNTs with various reproducible thicknesses of silica by using an electrochemical sol-gel process. In one of the examples, a SWNT mat was used as a working electrode for the direct deposition of silica. In another example, nanotubes were dispersed in solution and silica was deposited onto these solubilized nanotubes in the presence of a platinum working electrode. Applying a negative potential results in the condensation of silica (e.g., a silica film) onto the SWNT surface. The thickness of the silica coating was controllably altered by varying the potential of the working electrode as well as the concentration of the sol solution. These methodologies have the advantages of ease of use, environmental friendliness, and utilization of relatively mild reaction conditions.

### Experimental Section

Reagents and Materials: Tetramethoxysilane (TMOS, 99%) was purchased from Aldrich Chemicals. High-pressure CO decomposition (HiPco) single walled nanotubes (SWNTs) were obtained from Carbon Nanotechnologies (Rice University, Houston, Tex.). The working electrode was either a carbon nanotube mat electrode (0.0027 g/cm²) or a platinum (Pt) foil electrode (1 cm²). The auxiliary electrode consisted of a platinum foil electrode while the reference electrode was comprised of an Ag/AgCl wire electrode.
Purification of SWNTs: SWNTs were purified using mild oxidizing conditions. In particular, SWNTs were oxidized, under a moist environment, at 180-300° C. in order to oxidize Fe to Fe₂O₃ (Chiang et al., J. Phys. Chem. B, 2001, 105, 8297; Park et al., J. Mater. Chem., 2006, 16, 141). The oxide was subsequently leached by treatment with HCl. It is expected that under these relatively mild oxidizing conditions, purification is not accompanied by extensive functionalization. The suspension of SWNTs in HCl was subsequently filtered through a 0.2 μm polycarbonate filter membrane. After washing repeatedly with distilled, deionized water, a thin self-assembled, free-standing mat consisting of SWNT bundles was peeled from the filtration membrane. The SWNT mats were then dried in a vacuum oven at around 60° C. for 24 hours to remove the excess water. This sample is referred to as the “SWNT mat” electrode.
Electrochemical functionalization: Electrochemical experiments were carried out in a one chamber (three-electrode cell) using a CH potentiostat instrument (Austin, Tex., USA). The electrochemical cell consisted of an aqueous solution of TMOS prepared by mixing 0.1 to 0.5 ml of tetramethoxy silane (TMOS) with 2.4 ml of 0.1 M KCl and 2 ml of ethanol. Ethanol acts as a common solvent for the mixing of TMOS and aqueous KCl solution, while KCl is used as a supporting electrolyte. Two different experimental procedures were utilized for the deposition of silica onto the carbon nanotube surface. The results derived from each protocol are analyzed separately.
Procedure 1: In this protocol, a SWNT mat (0.0027 g) was used as the working electrode. The carbon nanotube mat electrode consisted of a rectangular area measuring 1.0 cm². An electrical contact was created by attaching a copper wire to the working electrode through silver epoxy. (The copper wire connects the working electrode to the CH potentiostat instrument.) A Pt foil electrode (area=1 cm²) was used as the counter electrode and an Ag/AgCl wire was utilized as the reference electrode. The potential of the working electrode was varied in the range from −500 mV to −1000 mV vs. Ag/AgCl. Electrodeposition was carried out for 5 minutes using chronoamperometry. Chronoamperometry is a commonly used electrochemical technique in which a constant potential is applied to the working electrode and the current is recorded as a function of time. After silica deposition, the nanotube mat electrode is immersed in water and sonicated in a horn sonicator for 2-3 min in order to debundle the tubes, followed by filtration and centrifugation to remove the excess silica not attached to the nanotubes themselves. The reaction products are then oven-dried at 60 to 70° C. In the control experiment, the working electrode (SWNT mat) was placed in the sol solution under identical conditions without applying any potential to the working electrode.
Procedure 2: In the second procedure, SWNTs (0.0027 g) were first ultrasonicated in an aqueous KCl (2.4 ml) and ethanol (2 ml) mixture so as to produce a stable dispersion followed by addition of TMOS (0.1 ml-0.5 ml) and subsequent sonication for a few more minutes. A Pt foil electrode (1 cm²) was used as the working electrode. Electrochemical functionalization of silica on SWNTs was carried out mainly using chronoamperometry. Potentials in the range of −700 mV to −1000 mV were applied to the working electrode for 10 min. Thereafter, the dispersion was filtered, washed repeatedly with water, and oven dried at 60 to 70° C. In the corresponding control experiment, the SWNT-sol dispersion was kept in an open circuit potential (i.e. no potential applied) for 10 min followed by filtration and washing.

In this specification, silica-coated SWNTs synthesized by procedure 1 are referred to as Si-SWNT-1; whereas those functionalized by procedure 2 are referred to as Si-SWNT-2. Associated control experiments are denoted as Si-SWNT-ctrl-1 and Si-SWNT-ctrl-2, respectively.
Characterization of silica functionalized SWNTs: Nanotubes were characterized using atomic force microscopy (AFM), scanning electron microscopy (SEM), high-resolution transmission electron microscopy (HRTEM), X-ray photoelectron spectroscopy (XPS), UV-visible spectroscopy (UV-Vis), mid- and near-Fourier transform infrared (FTIR) spectroscopy as well as Raman spectroscopy.
Atomic Force Microscopy: AFM height images of purified and silica-coated SWNTs were obtained in Tapping mode in air at resonant frequencies of 50-75 kHz with oscillating amplitudes of 10-100 nm. Samples were dispersed in DMF, spin coated onto a highly oriented pyrolytic graphite (HOPG) substrate, and imaged using conventional Si tips (k=3-6 N/m) with a Multimode Nanoscope IIIa (Digital Instruments, Santa Barbara, Calif.). Height measurements of pristine and of the silica-coated nanotubes were taken using the Nanoscope analysis software along a number of different, randomly selected section profiles of the individual tube bundles. The height data for all of the tubes were collected and subsequently averaged over a minimum of 35-40 tubes. The experiments reported herein were performed on nanotube bundles as opposed to on individualized tubes, because to avoid any possibility of complicated, unforeseen reactivity associated with the nanotube dispersing agent, e.g. the surfactant such as SDS. Herein is described a demonstration of principle for coating nanotubes, requiring minimal chemical manipulation of readily-available commercial tubes, which tend to occur as bundles. Hence, the methodology herein can be readily generalized to individual tubes, for instance, grown in situ on surfaces.

The height data recorded for silica-coated tubes accurately reflected only those regions of the tube bundles where an obvious coating was present. Not all of the tubes possess a continuous surface coating of silica, especially with respect to the thicker coatings. Hence, the actual thickness of the silica film could be obtained by subtracting the average height of the uncoated sections of the tube bundles from the coated regions of tube bundles in the same sample. The heights of uncoated tubes were found to be within statistical error of the measured heights of pristine tubes and of tubes subjected to control experimental conditions (i.e. Si-SWNT-ctrl-1 and Si-SWNT-ctrl-2).
Electron Microscopy: Samples for HRTEM were obtained by drying aliquot droplets from an ethanolic solution onto a 300 mesh Cu grid coated with a lacey carbon film. HRTEM images were obtained on a JEOL 201 OF high-resolution transmission electron microscope, equipped with an Oxford INCA EDS system at an accelerating voltage of 200 kV. An aliquot of an ethanolic solution of the sample was drop dried onto Cu grids and held over a beryllium plate localized inside a homemade sample holder. Samples were imaged with a field emission SEM (FE-SEM Leo 1550 with EDS capabilities) using accelerating voltages of 5-10 kV at a 2 mm working distance.
X-ray Photoelectron Spectroscopy: For XPS analysis, solid samples were attached onto stainless steel holders using a conductive double sided tape and installed in the vacuum chamber of a XPS surface analysis system (Kratos Analytical Plc model DS800). The chamber was evacuated to a base pressure of about 5·10⁻⁹ Torr. A hemispherical energy analyzer was used for electron detection. XPS spectra were first collected using a Mg K X-ray source at an 80 eV pass energy and at 0.75 eV steps per sample. Higher-resolution spectra were collected at a pass energy of 10 eV at 0.1 eV steps.
Optical Spectroscopy: FT-mid-IR data were obtained on a Nexus 670 (Thermo Nicolet) equipped with a single reflectance zinc selenide (ZnSe) ATR accessory, a KBr beam splitter, and a DTGS KBr detector. Solid samples were placed onto a ZnSe crystal. Measurements were obtained in absorbance mode using the Smart Performer module. For FT-near IR work, a CaF₂ beam splitter and an InGaAs detector were used. UV-visible spectra were collected at high resolution using a Thermospectronics UV 1 with quartz cells maintaining a 10-mm path length. Samples were prepared by sonication in o-dichlorobenzene (ODCB). Data were corrected to account for the solvent background.
Raman Spectroscopy: Raman spectra were obtained on solid samples dispersed in ethanol and placed onto a Si wafer. Spectra were obtained on a Renishaw 1000 Raman microspectrometer with excitation from argon ion (514.5 nm), He—Ne (632.8 nm), and diode (780 nm) lasers, respectively. A 50× objective and low laser power density were used for the irradiation of the sample and for signal collection. The laser power was kept sufficiently low to avoid heating of the samples by optical filtering and/or defocusing of the laser beam at the sample surface. Spectra were collected in the full range of 3000-100 cm⁻¹ with a resolution of 1 cm⁻¹.

### Results and Discussion

### Electrodeposition of Silicate Film on SWNTs:

Procedure 1: In the electrodeposition process, the application of a constant negative potential to the working electrode causes generation of hydroxide ions at the electrode surface via reduction of water and dissolved oxygen (Deepa et al., Anal Chem., 2003, 75, 5399; Shacham et al., Adv. Mater., 1999, 11, 384; Bard et al., Electrochemical Methods. Fundamentals and Applications New York, 1980; Bockris et al., Surface Electrochemistry New York, 1993; Aldykiewicz et al., J. Electrochem. Soc., 1996, 143, 147; Kuhn et al., J. Appl. Electrochem. 1983, 13, 1897). This process is also accompanied by the reduction of protons at the electrode surface. The generation of OH⁻ increases the local pH around the working electrode. This increased local pH will result in the base-catalyzed hydrolysis and condensation of TMOS with the consequent formation of a silica film of controllable diameter on the electrode surface (Deepa et al., Anal. Chem., 2003, 75, 5399; Shacham et al., Adv. Mater., 1999, 11, 384). The production of OH⁻ depends on the nature of the electrode surface. Details of the mechanism surrounding the localized electrode reaction can be found in “Supporting Information Available” section below.

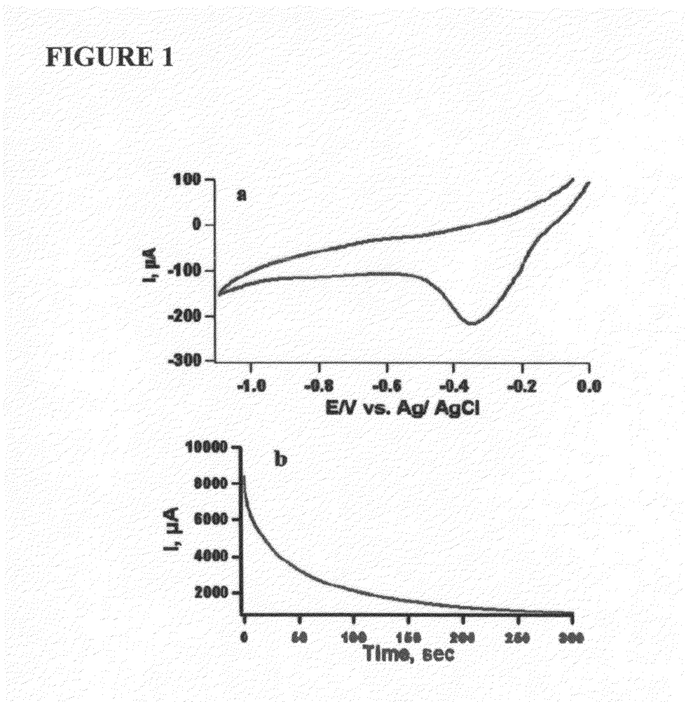

FIG. 1a shows the cyclic voltammogram of a carbon nanotube mat electrode in a TMOS sol containing 0.1 ml of TMOS, 2.4 ml of 0.1 M KCl, and 2 ml of ethanolic solution. KCl was used as the supporting electrolyte. It can be observed that for the carbon nanotube mat electrode, a broad reduction wave occurs at around −350 to −400 mV. This peak has been attributed to the reduction of oxygen to OH⁻ near the electrode surface, resulting in electrodeposition of the silicate film. It was found that applying a potential less negative than −300 mV did not result in any silica deposition on the nanotube surface under aerated conditions. To verify the appropriateness of these conditions, a cyclic voltammogram was recorded in a deaerated TMOS sol saturated with nitrogen. In this case, no reduction wave appears and hence, no silica film was deposited onto the SWNT mat electrode at potentials less negative than −800 mV under nitrogen. Thus, from these observations, silica electrodeposition on the SWNT mat electrode was carried out ambiently at negative potentials ranging from −500 mV to −1000 mV.

FIG. 1b shows the current-time plot recorded at the carbon nanotube mat electrode following a potential step from 0 to −700 mV. Applying a cathodic current density to the electrode surface (−0.1 mA/cm² to −0.3 mA/cm²) also results in the appearance of silicate films electrodeposited onto the electrode surface. Considering that, after each experiment, SWNT-silica adducts were ultrasonicated and washed repeatedly after centrifugation and filtration, it is reasonable to assume that the silica films on the carbon nanotubes adhered tightly to the carbon nanotube surfaces, as can be seen from SEM and AFM data discussed later in the specification. This observation has been attributed to the mediation of oxygenated groups such as alcohol, ketone/aldehyde, carboxylic acid, and epoxy functionalities on the SWNT surfaces which can readily bond to the silica film (Park et al., J. Mater. Chem., 2006, 16, 141; Li et al., Phys. Rev. Lett 2006, 96, 176101 ;Deepa et al., Anal. Chem., 2003, 75, 5399).
Procedure 2: In this case, a Pt foil (1 cm²) was used as the working electrode with the carbon nanotubes dispersed in the sol. Applying a constant negative potential to the Pt electrode results in the production of OH- ions and an increase in the local pH near the vicinity of the Pt electrode as well as a corresponding rise in the local pH of the sol itself near the electrode. The silica film can hence be deposited onto the Pt electrode as well as onto the carbon nanotubes dispersed in the sol solution.

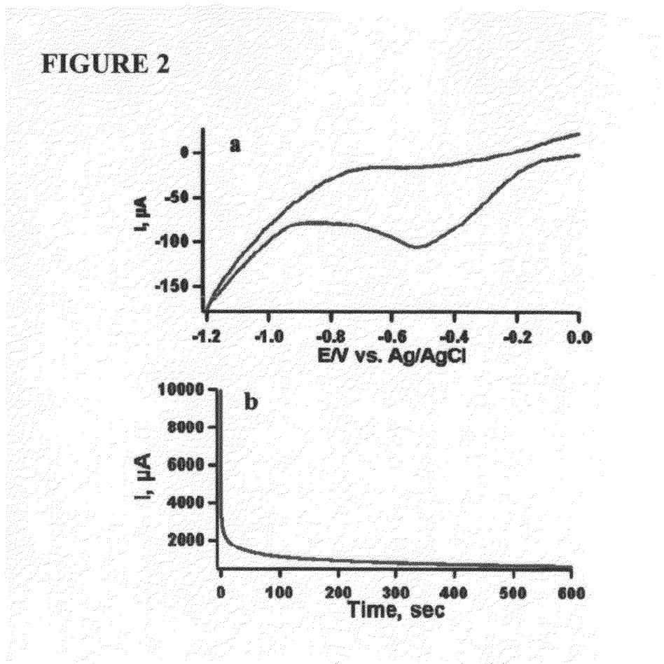

FIG. 2 shows the cyclic voltammogram of the Pt electrode in the presence of a TMOS sol. For the Pt electrode, the reduction of O₂ to OH⁻ ions begins at a potential more negative than −500 mV. Indeed, the application of a less negative potential to the Pt electrode does not result in silica deposition either onto the nanotubes or onto the Pt foil itself. This suggests that, for Pt, the electrodeposition process itself commences at a potential more negative than −500 mV. Therefore, in this case, a range of potentials from −700 mV to −1000 mV could be applied to the Pt working electrode to induce deposition. It is noted that a mixed deposit of carbon nanotubes and silica on the Pt foil did not adhere well to the electrode surface with the composite film often flaking off.

From the SEM images shown for these samples, it seemed as if the carbon nanotubes, deposited on the Pt electrode, were encapsulated by silica (FIG. S1). A similar phenomenon has been observed by other groups while depositing a film of silica onto a platinum electrode by means of the sol-gel technique (Deepa et al., Anal. Chem., 2003, 75, 5399).

By contrast, carbon nanotubes suspended in solution were covered with a silica film that adhered strongly to the nanotube surface. Hence, in this specification, silica-coated SWNTs were primarily analyzed, either dispersed in the sol (Si-SWNT-2) or from a carbon nanotube mat electrode (Si-SWNT-1), by a number of different analytical characterization techniques, including microscopy and spectroscopy.
Summary of characterization protocols: Silica-coated nanotubes, synthesized by Procedures 1 and 2, were characterized extensively using AFM. AFM height images were recorded for silica-coated nanotubes as a function of applied potential as well as the concentration of the sol solution. Structural characterization was confirmed by electron microscopy (including SEM and HRTEM). Spectroscopic techniques such as XPS, IR, and Raman were also utilized as tools to characterize these adducts.

### AFM Characterization

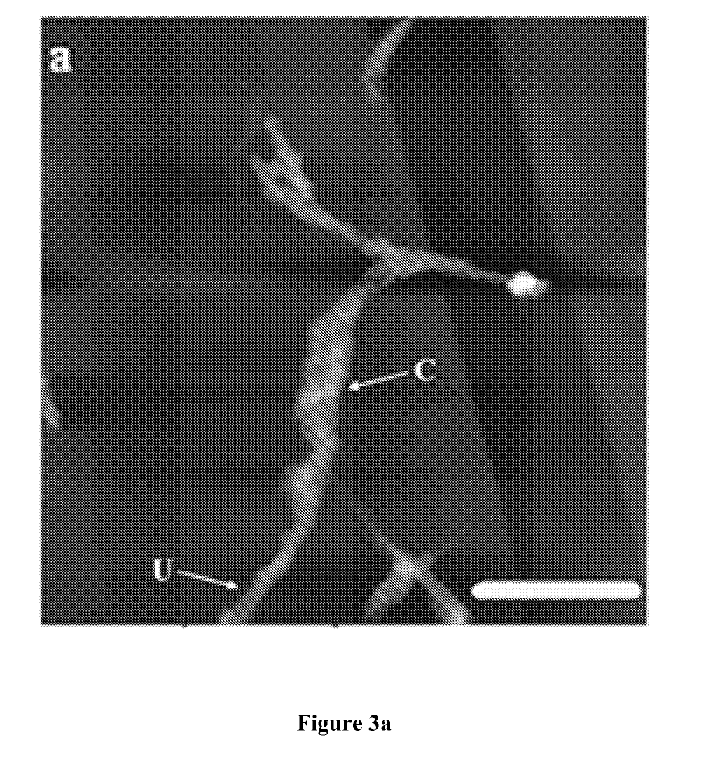

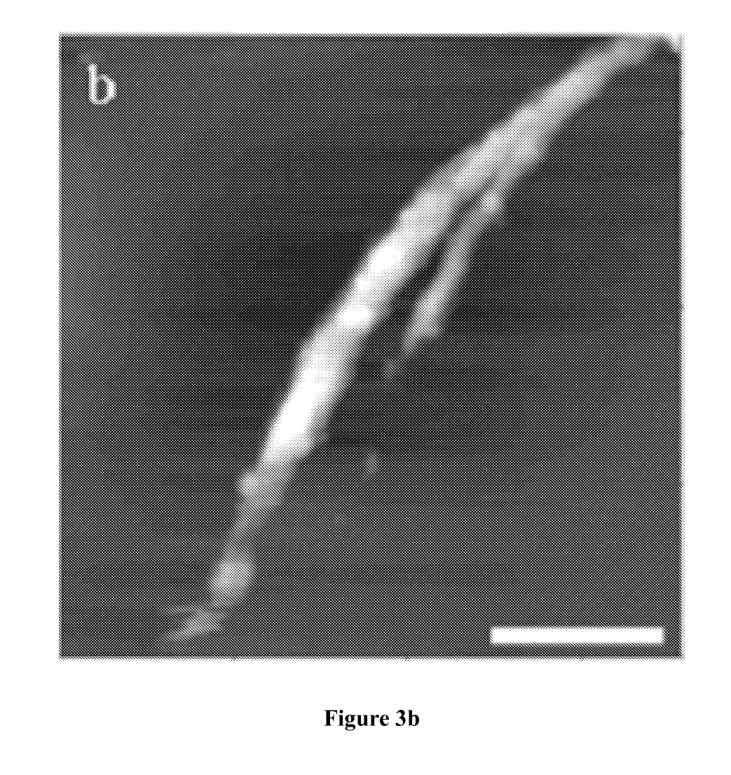

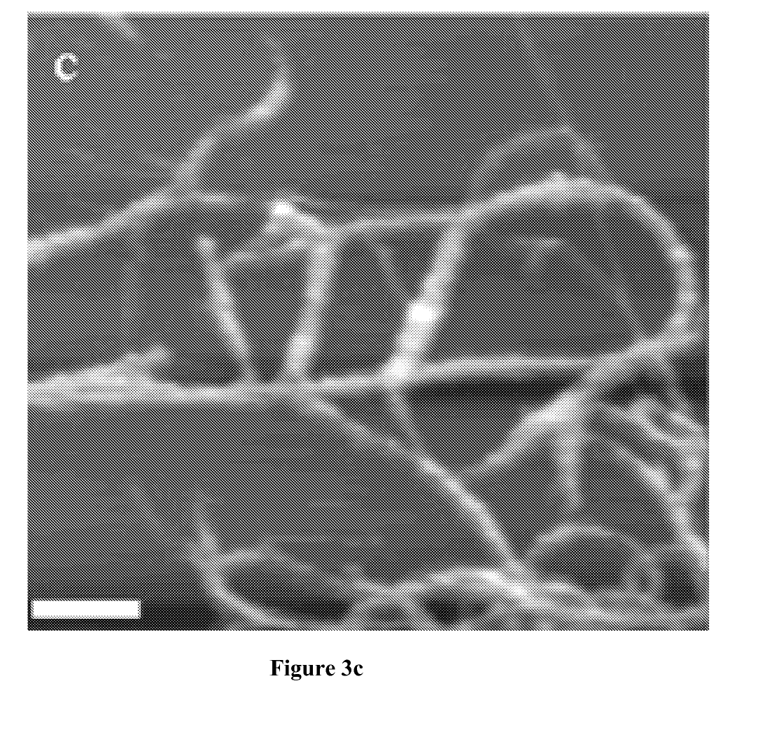

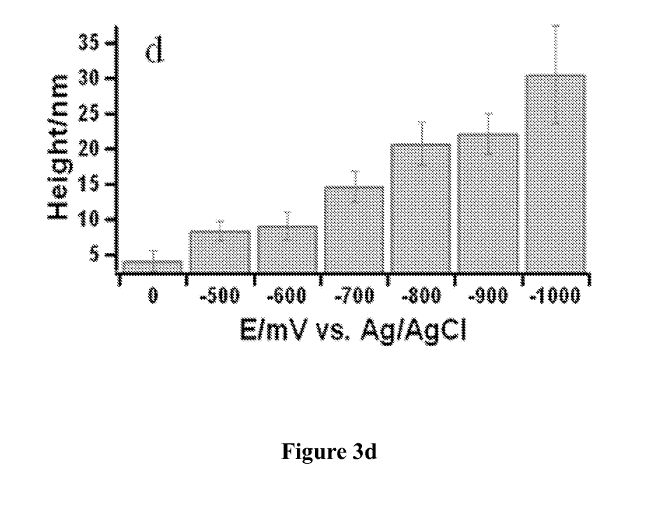

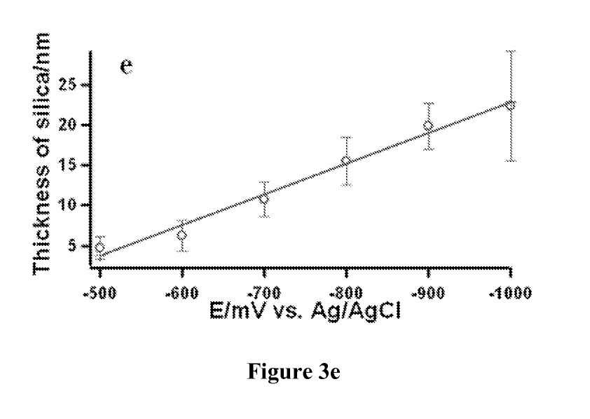

Functionalized tubes synthesized by procedure I. FIGS. 3a, b, and c show AFM height images of SiOₓ-coated SWNTs (Si-SWNT-1), prepared from deposits isolated from the SWNT mat electrode at −500 mV, −700 mV, and −1000 mV respectively. As seen from the Figure, in a prevailing motif it has been noted in all of the experiments, silica attaches to the carbon nanotubes as a continuous, roughened coating.

It is observed that the silica coating appears to consist of a particulate mass composed of spherical aggregates. This can be attributed to the nature of the base-catalyzed condensation process (Iler, R. K., The Chemistry of Silica New York, 1979). In the electrodeposition process, sol condensation occurs first followed by solvent evaporation and subsequent drying, yielding a particulate texture in the resulting film. It was also noted that with increasing negative potential, the thickness of the film increased. This can be explained by the fact that either the application of an increasing negative potential or a cathodic current density to the working electrode will increase the generation of OH⁻ ions, which in turn will increase the local pH surrounding the electrode, thereby encouraging and accelerating the electrodeposition process. It is known that the sol-gel process produces deposited films whose morphology is particulate in nature and whose structure is dependent on a variety of factors including but not limited to precursor size, structure, and reactivity, relative rates of condensation and evaporation, and liquid surface tension (Brinker et al., Thin Solid Films, 1991, 201, 97). Hence, because of the grainy nature of the product of the base-catalyzed sol-gel process, an increase in film thickness correlated with an increase in surface roughness of the silica coating. That is, thicker coatings, generated at increasing potentials, tended to be more variable from the perspective of both height and roughness measurements. One need only compare the results at −500 mV vs. −700 mV to note the conspicuously more continuous, smoother film (i.e. thinner coating) associated with the run at the less negative potential.

FIG. 3d shows a plot of apparent tube height vs. applied potential for Si-SWNT-1 tubes. Data were obtained from height measurements of an average of 45-50 nanotubes. FIG. 3e shows a plot of the thickness of a silica-coated film on SWNTs vs. the applied potential. Average thicknesses of these films were obtained by subtracting the average height of SiSWNT-ctrl1 from that of Si-SWNT-1 tubes at the same potential.

As previously mentioned, it is noted that in some cases, there are some portions of the tube, which are not coated with silica, as seen from the Figures. This observation can be accounted for by (a) the orientation of the individual tubes in the mat electrode, (b) the entanglement of tubes within the mat electrode, and (c) the lack of physical exposure of some portions of the tube bundles to the sol itself during the reaction process. Moreover, for thicker coatings of silica, physical cracking was observed in some instances, which could either be partially attributed to sample drying under non-optimized conditions or to sample breakage occurring during vigorous ultrasonication of the carbon nanotube mat electrode in an effort to isolate individual tubes.

The plot shows a linear increase in the thickness of the film as a result of an increase in the magnitude of the negative potential (R²=0.965). The thickness of the silica films on carbon nanotubes was observed to vary from ˜4.4±1.3 nm to 26.6±6.8 nm by tuning the magnitude of the negative potential applied from −500 mV to −1000 mV with an observed increase in thickness found to deposit at a rate of 0.044 nm/mV. This quantitative result highlights the ability to initiate controllable deposition of silica onto the carbon nanotube surface through a reproducible electrodeposition process.

In all experiments run, more than 80% of the tubes were found to be coated with silica, an observation attributed to the fact that the majority of as-synthesized carbon nanotube mat electrodes were deliberately synthesized with a low enough density (270 μg/cm²) of tubes to ensure that the vast majority (i.e. maximal surface area) of individual nanotubes within the mat itself would be exposed to the sol solution. Conversely, in electrodes consisting of denser mats of nanotubes (˜1000 μg/cm²), only the outer layers were observed to have been coated with silica.

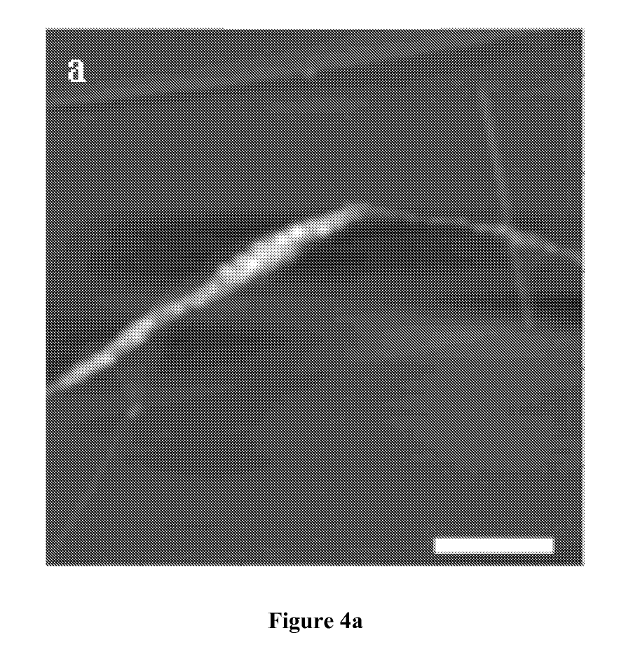

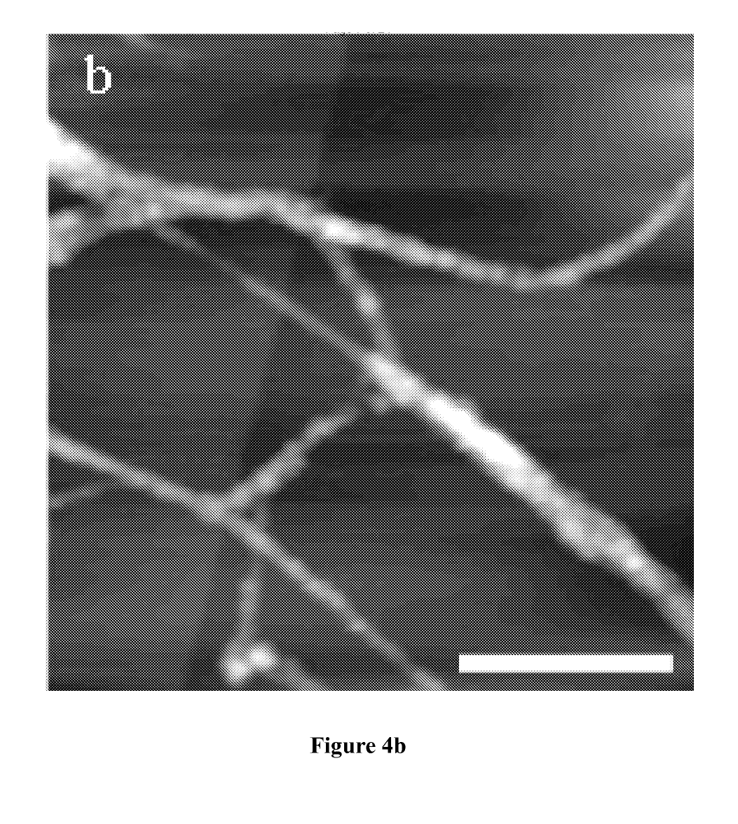

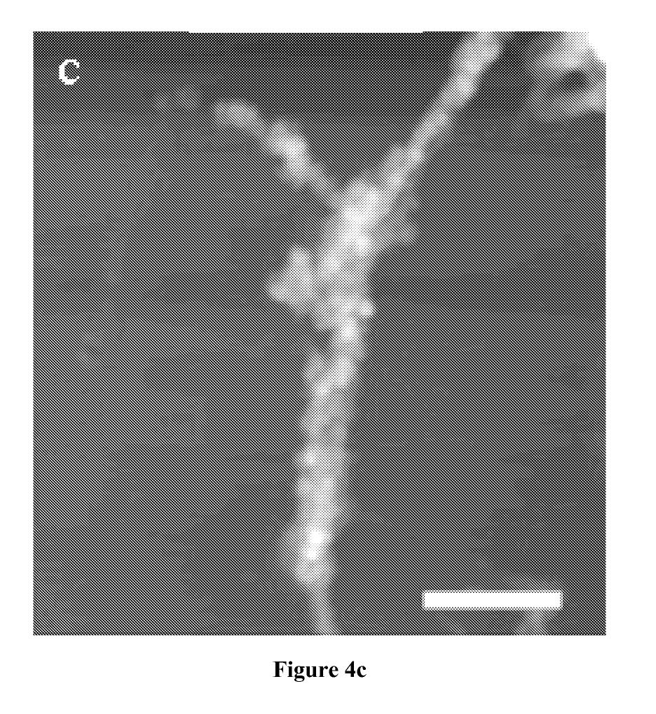

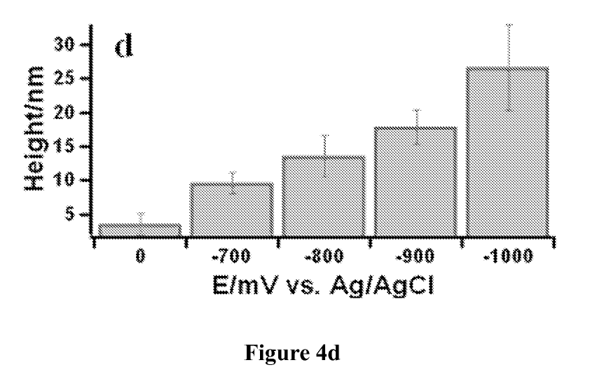

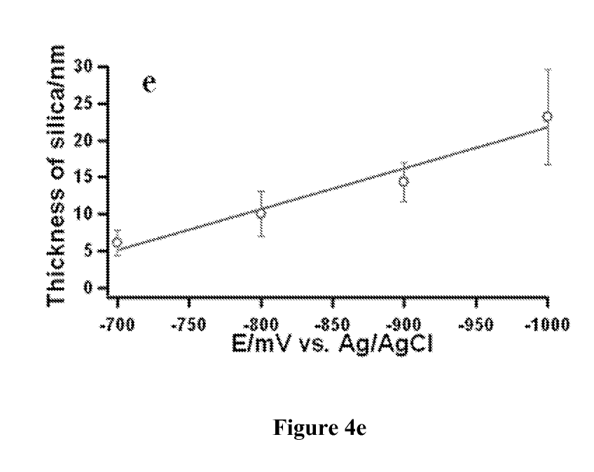

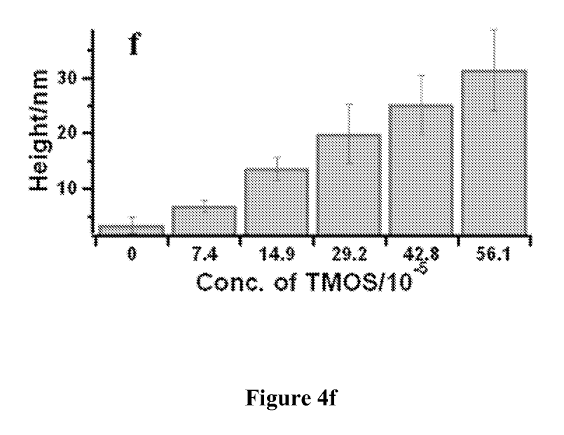

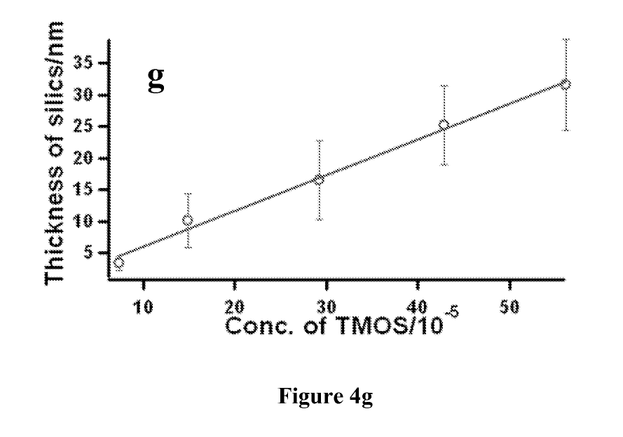

Functionalized tubes synthesized by Procedure 2: FIGS. 4a-c shows AFM height images of the silica-coated SWNTs that were electrodeposited by dispersing carbon nanotubes in a sol solution in the presence of a Pt foil working electrode at −800 mV, −900 mV, and −1000 mV, respectively. The particulate nature of the silicate film is very clear from the AFM images. In this case, the formation of a silicate film commences at potential values more negative than −500 mV. As mentioned previously, a certain mass of carbon nanotubes were deposited along with silica onto the Pt foil electrode itself, forming thick white flaky films, with observed silica thicknesses noted to be much larger than those associated with the carbon nanotubes in solution.

The formation of silica-coated carbon nanotubes in solution (Si-SWNT-2) was attributed to an increase in the local pH of the sol solution in the vicinity of the electrode surface, conditions conducive to gelation of sol onto the carbon nanotube bundles (effectively each individually behaving as an electrode) dispersed in the solution. It should be mentioned that the solution was sonicated rigorously prior to the electrodeposition process to ensure nanotube dispersability and homogeneity in the reaction medium. It was also noted that there is a larger variation in detected heights amongst the silica-coated nanotubes in these samples, a fact explained by the dependence of the thickness of the coating on the distance of the carbon nanotubes from the working electrode. As the localized increase in pH will be highest near the Pt electrode, therefore, SWNTs in closest proximity to the Pt electrode will possess a thicker silica coating as compared with nanotubes farther away from the electrode.

FIG. 4d shows AFM height images of as-prepared silica-coated nanotubes as a function of applied potential. As expected, the apparent heights of the tubes (and incidentally, surface roughnesses of the resulting silica films) increase with increasing negative potential. FIG. 4e shows the plot of corresponding thickness of the silica film vs. applied potential. The thickness of the silica film on the carbon nanotube was found to increase linearly with a slope of around 0.055 nm/mV (R²=0.961). With this protocol, approximately 65% of carbon nanotubes were found to be coated with silica as compared with 80% noted for nanotubes coated by Procedure 1. Data indicate that not only the percentage of tubes coated can be significantly increased but also the thickness variation can be correspondingly decreased by continuous stirring of the reagent solution during electrodeposition. The behavior of silica thickness as a function of TMOS concentration was also studied (Supplementary FIG. S2). Specifically, the height of silica-coated nanotubes was measured as function of silica concentration in solution (7.4·10⁻⁻⁵ M, 1.49·10⁻⁴ M, 2.92·10⁻⁴ M, 4.28·10⁻⁴ M, and 5.6·10⁻⁴ M) (FIG. 4e) at an applied electrode potential of −800 mV vs. the Ag/AgCl electrode. The thickness of the silica coating was found to increase linearly with silica concentration, varying from 3.4±1.2 nm to 31.5±7.2 nm over the concentration range (FIG. 4f). The slope of the corresponding curve, an empirical correlation between thickness and TMOS concentration, was determined to be 56.4 nm/mM (R²=0.993).

### Electron Microscopy Characterization

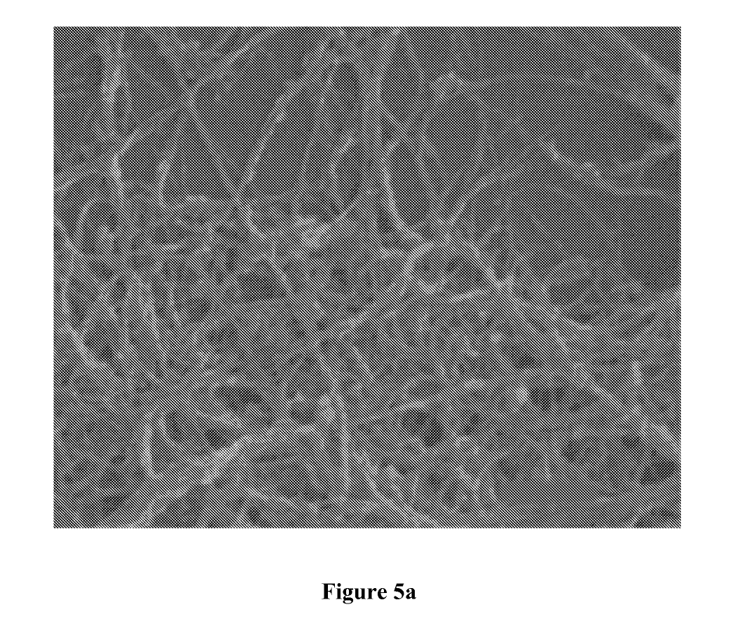

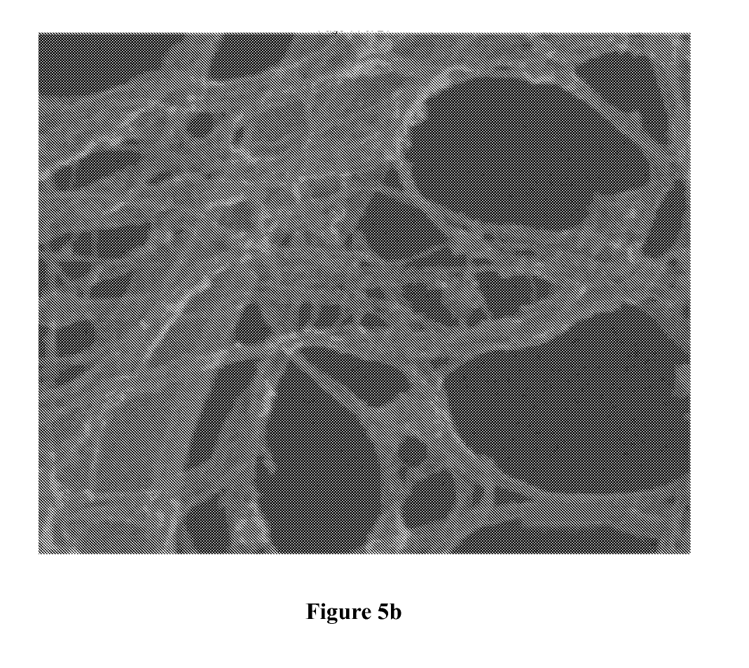

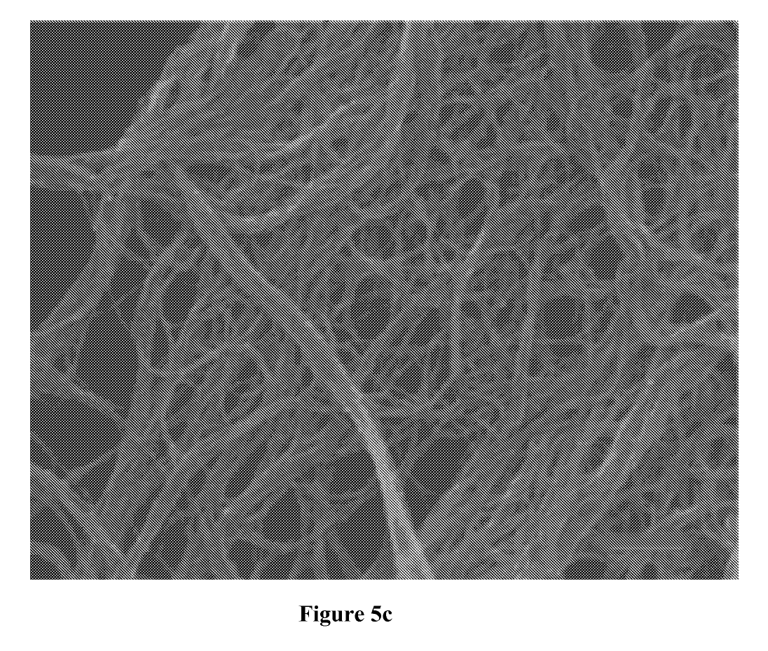

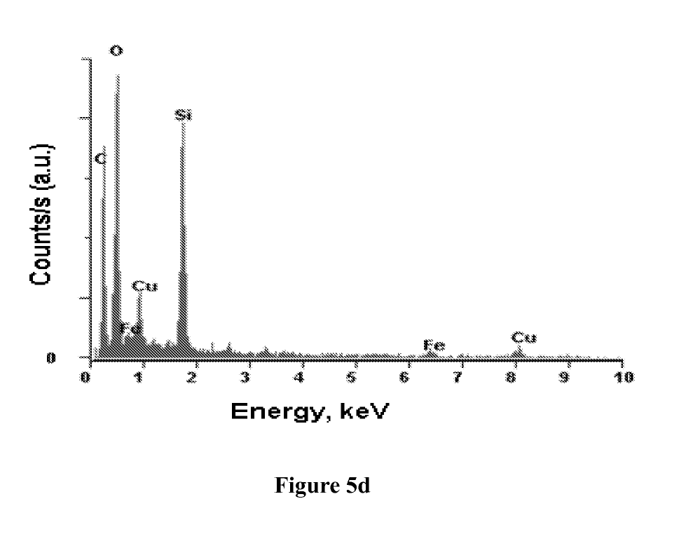

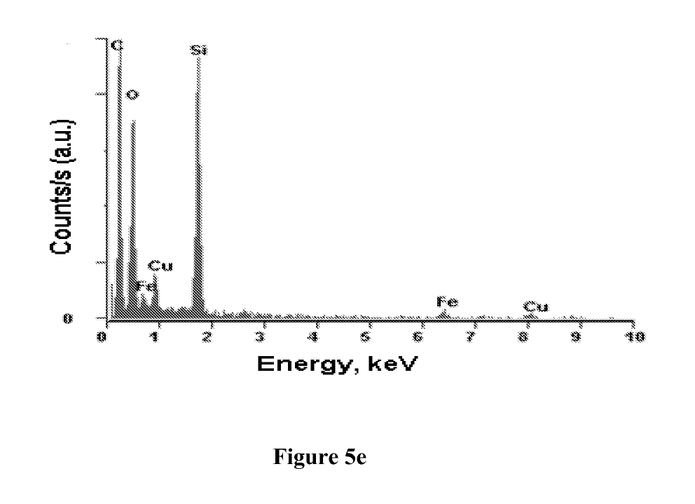

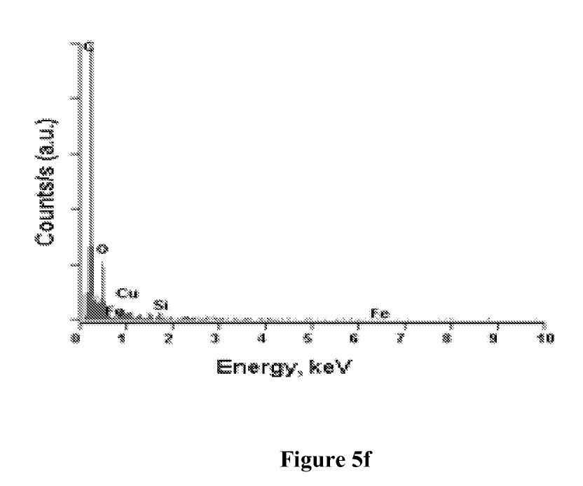

Functionalized tubes synthesized by Procedure 1: FIG. 5a shows the SEM image and the corresponding EDS spectrum of silica-coated SWNTs (Si-SWNT-1), synthesized by electrodeposition at an applied potential of −1000 mV. The EDS spectrum (FIG. 5d) shows the presence of a strong Si peak, which is absent in the purified, unfunctionalized SWNTs (PSWNT) as shown in FIG. 5f. The oxygen peak of Si-SWNT-1 is also stronger as compared with the EDS spectrum of purified, unfunctionalized SWNTs (FIG. 5f), indicating the likely presence of SiO₂ on the SWNT surface.

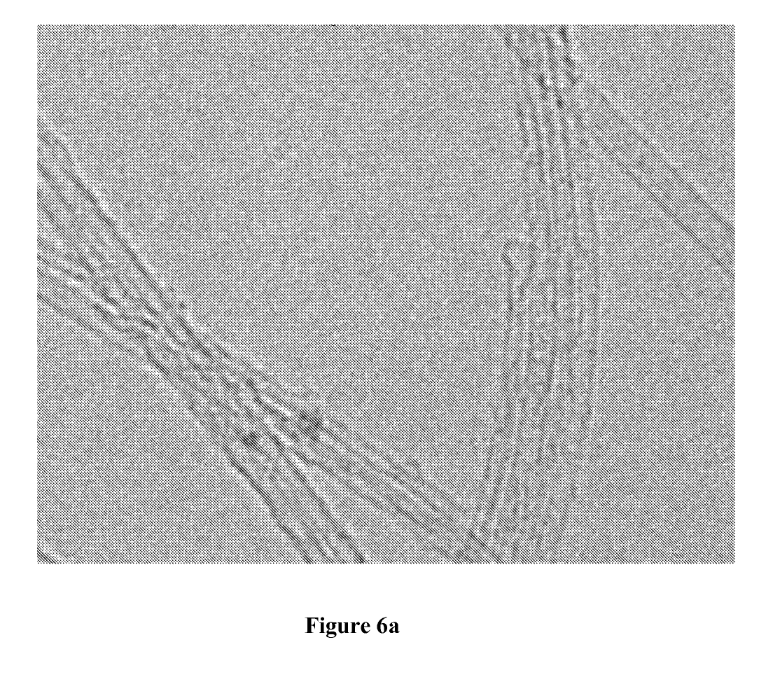

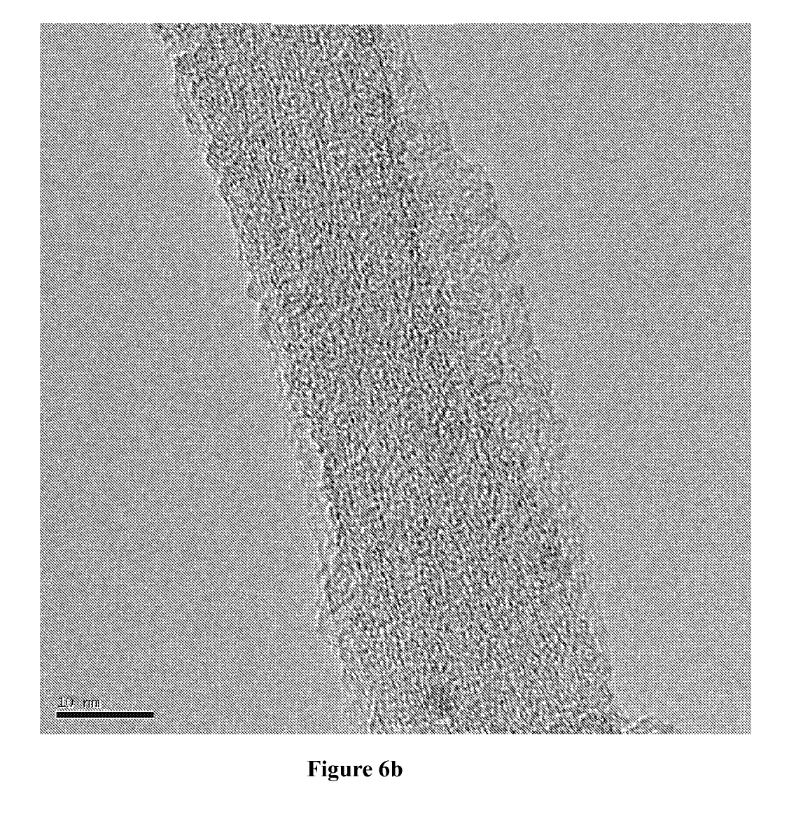

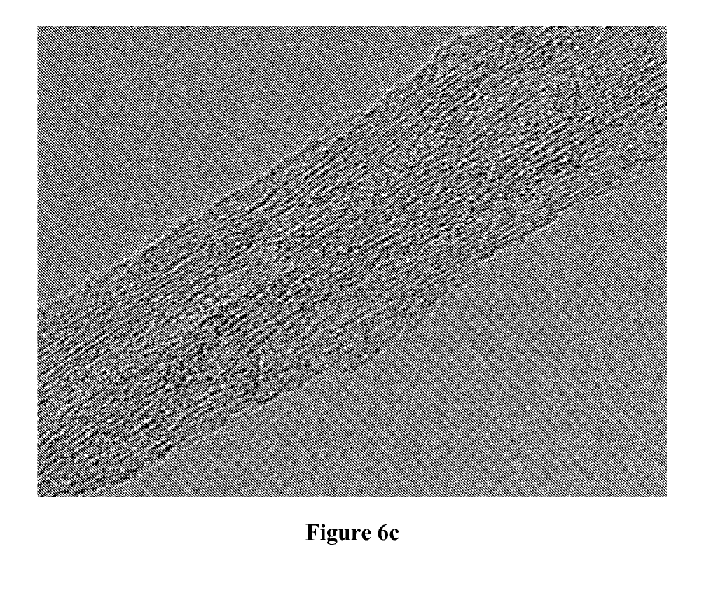

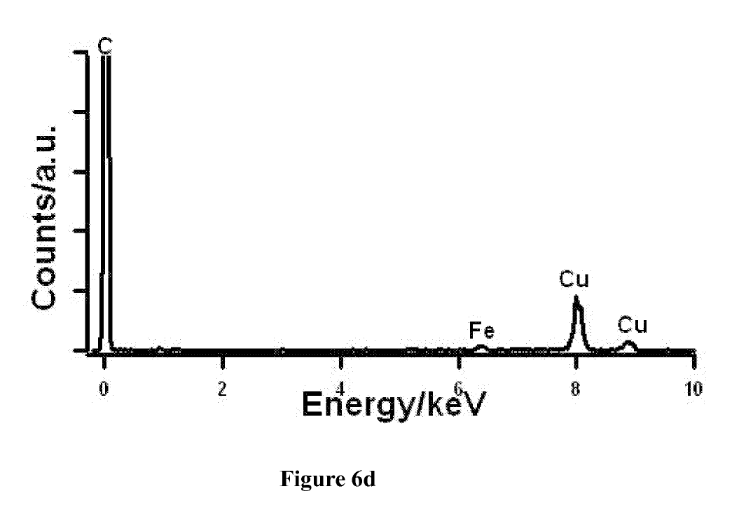

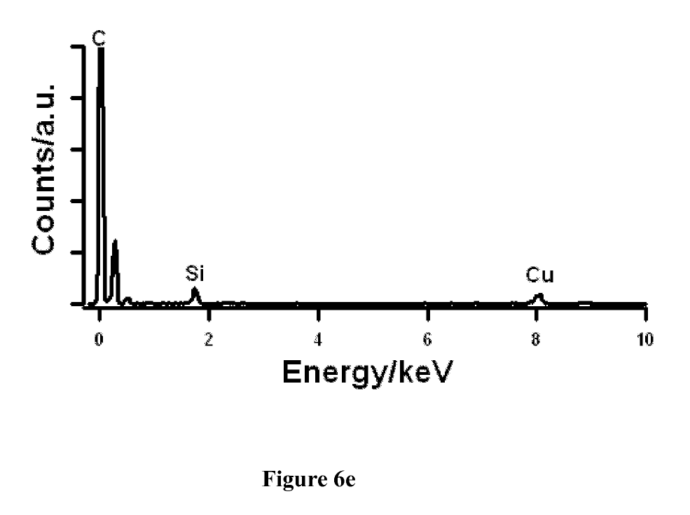

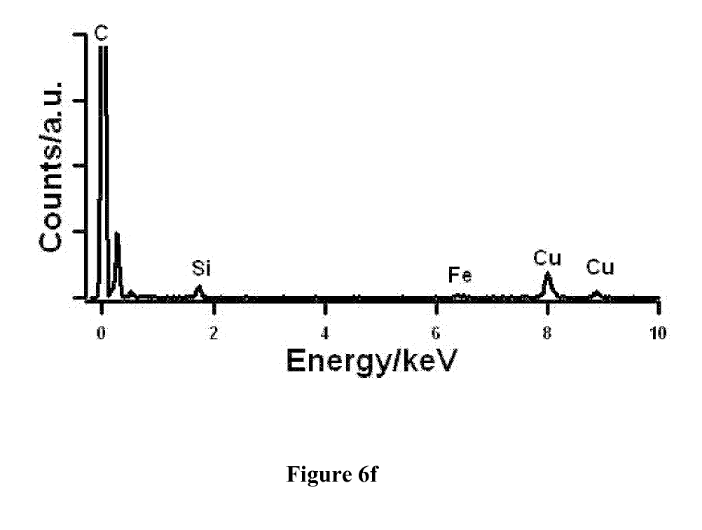

The presence of a silica coating on Si-SWNT-1 was further confirmed by HRTEM images (FIG. 6). FIG. 6a shows an HRTEM image and corresponding EDS spectrum (FIG. 6d) of purified tubes; it is noteworthy that Si is absent from the EDS spectrum of these cleaned tubes. FIG. 6b represents the HRTEM image of carbon nanotubes coated with silica (Si-SWNT-1) at −600 mV. The carbon nanotube structure is clearly intact indicating that it is not destroyed by the electrochemical silylation process. In addition, the presence of a mostly roughened, amorphous coating of silica on the functionalized, small SWNT bundles was observed. The silica film is particulate in nature in agreement with AFM data. The Si peak in the corresponding EDS spectrum (FIG. 6e) of those tubes is consistent with the presence of silica on the nanotube surface. The presence of Fe can be attributed to the presence of residual impurities in the sample. FIG. 6c shows the HRTEM image of another set of carbon nanotubes coated with silica (Si-SWNT-2) at −700 mV. Again the physical structure of these tubes remained relatively unaffected through this mild nondestructive method of functionalizing carbon nanotubes. The presence of silica was confirmed by the EDS spectrum (FIG. 6f) and was noted to be amorphous in nature. Additional HRTEM results on other tubes/bundles in FIG. S3 further reinforce the validity of the methodology in coating tubes with silica.

The SEM and the corresponding EDS spectrum (e.g. negligible quantities of Si) of the control tubes (Si-SWNT-ctrl-2; FIG. S4), in which the SWNT mat electrode was placed in the sol solution for 5 minutes at an open circuit potential, resemble analogous data for purified, unfunctionalized SWNTs (FIG. 5c). It is also noted that the nanotubes in both the purified and silica-coated samples tend to occur as small bundles measuring 4 to 10 nm in diameter.
Functionalized tubes synthesized by Procedure 2: FIG. 5b shows the SEM image and the corresponding EDS spectrum of SWNTs (Si-SWNT-2), electrodeposited at a potential of −1000 mV. The presence of a strong Si peak combined with an oxygen peak indicates the likelihood of silica on the surfaces of these tubes. The presence of silica on the functionalized carbon nanotubes was further confirmed by HRTEM images showing the presence of an amorphous but roughened coating on the SWNT surface (FIG. 6c). Conversely, as mentioned previously, the control experiment does not show the presence of a Si peak in the EDS spectrum.

### Spectroscopy

Interpretation by XPS spectra: XPS was used to reveal the surface state composition of SWNTs before and after silica coating. High-resolution data for samples analyzed can be found in Supplemental FIGS. S5-S7. (See “Supporting Information Available” below.) The XPS atomic concentrations of purified, air-oxidized SWNTs (C=81.10%, O=13.91%, Si=1.29%) are evidence for the presence of carbon and oxygen with a trace quantity of Si in the precursor tubes. The presence of Si, fluorine, sulfur, and chloride can be assigned to intrinsic impurities associated with as-purchased nanotubes. The presence of oxygen, however, can be attributed to extant surface oxides on the carbon nanotubes.

Si-SWNT-1 synthesized at a potential of −1000 mV (C=43.72%, O=40.27%, Si=15.43%) suggests that the functionalization process had a direct correlation with the amount of Si observed. The atomic concentration of oxygen increased as well, corroborating the possible formation of SiO₂. Conversely, the XPS atomic concentrations measured of Si-SWNT-ctrl-1 (C=86.97%, O=9.71%, Si=1.53%) show the composition of carbon, oxygen and silicon to be approximately the same as that of pristine SWNTs.

The high-resolution C Is spectra of purified, air-oxidized SWNTs reveal peaks in the range of 283-292 eV. The main peak (284.59 eV) has been attributed to the C 1s signal of graphitic carbon, while other peaks have been assigned to —C—OH (286.1 eV), —C═O (287.5 eV) and —COOH (289.13 eV) groups respectively, indicating the presence of oxygenated functional groups on the carbon nanotube surface due to air oxidation (Okpalugo et al., Carbon, 2005, 43, 153; Martinez et al., Carbon, 2003, 41, 2247). From the C 1s and O 1s spectra, the purified carbon nanotubes were determined to possess approximately 30% functional group derivatization with the presence of —OH, —COOH and —C═O groups, respectively.

The high-resolution C Is peaks of Si-SWNT-1 (284.56, 286.50, 288.00, and 289.01 eV) were found to minimally shift with respect to those of purified, air-oxidized SWNTs, suggestive of the lack of covalent functionalization of the SWNT surface (Whitsitt et al., J. Mater. Chem., 2005, 15, 4678). The high-resolution Si 2p spectrum shows a peak located at 104.11 eV, which can be attributed to the SiO₂ signal, resulting from a siloxane network (Si—O—Si) of bonds originating from the condensation of silane molecules. The apparent absence of either Si—O—C or Si—C bonding suggests that the silica is attaching to the SWNT surface through van der Waals interactions. Atomic concentrations (%) of the elements and the relative percentages of these elements in the various samples are given in Table 1.

TABLE 1
XPS data of Atomic Concentrations (%) of elements on the surfaces
of purified, silanized and control nanotube samples.

| Sample | C | N | O | F | Si | S | Cl | Fe |
|---|---|---|---|---|---|---|---|---|
| Purified | 81.1 | 0.73 | 13.9 | 1.70 | 1.29 | 0.89 | 0.38 | — |
| SWNTs | | | | | | | | |
| Control sample | 87.0 | — | 9.71 | 1.25 | 1.53 | — | — | 0.55 |
| (SWNT-Ctrl-1) | | | | | | | | |
| Silanized | 43.7 | — | 40.3 | 0.57 | 15.4 | — | — | — |
| SWNTs | | | | | | | | |
| (Si-SWNT-1) | | | | | | | | |

UV-Visible near IR Spectroscopy: FIG. 7a shows the UV-visible spectra of purified, air-oxidized SWNTs, Si-SWNT-1, Si- SWNT-2, and pristine SWNTs, respectively. The spike-like features observed in the UV-visible spectra of the pristine SWNTs can be attributed to optical transitions originating between van Hove singularities of the local electronic density of states of the nanotubes. In the UV-visible spectra, distinctive peaks corresponding to the second transition of semiconducting SWNTs (550-900 nm) and the first transition of metallic tubes (400-600 nm) can be observed for purified HiPco tubes as well as for the Si-SWNT-Ctrl-1 and Si-SWNT-Ctrl-2 control tubes, as reported in the literature (Chen et al., Science, 1998, 282, 95; Bahr et al., Chem. Mater., 2001, 13, 3823). These spike-like features are retained in the signal due to the purified, air-oxidized samples, suggesting that mild air oxidation neither destroys nor adversely affects the electronic properties of tubes, an assertion supported by the Raman data.

On the other hand, features in the UV-visible spectra of silica-coated tubes are diminished to a certain extent and these are not as clearly distinctive as those of uncoated SWNTs. It must be stressed though that there is a minor attenuation, a complete loss of the intensity of the observed transitions which would have been indicative of covalent sidewall functionalization was not found. This piece of evidence further supports the noncovalent nature of the chemical interaction between SWNTs and SiO₂ (Tour et al., Chem. Eur. J., 2004, 10, 812).

FIG. 7b shows the FT-mid-IR spectra of silica-coated nanotubes prepared by procedures 1 and 2 (Si-SWNT-1 and Si-SWNT-2) under conditions of electrodeposition at −1000 mV. The mid-IR spectrum of these functionalized tubes show peaks located at 1074 cm⁻¹ and 790 cm⁻¹, suggestive of the presence of a Si—O—Si bonding network on the carbon nanotubes. A shoulder at 920 to 970 cm⁻¹ is consistent either with Si—O stretching of the Si—O-aromatic group or with the benzene ring of the carbon nanotubes. Therefore, the presence of all of the above mentioned spectroscopic signals is consistent with a silica coating on the carbon nanotube surface.

FT-near-IR measurements (FIG. 7c) of the pristine, control, and air-oxidized nanotubes show peaks in the ˜6000-7500 and ˜8000-9500 cm⁻¹ regions, corresponding to transitions between the first and second set of van Hove singularities in the semiconducting tubes, respectively (Chen et al., Science, 1998, 282, 95; Sen et al., Chem. Mater., 2003, 15, 4723). As a general comment, sharp, discrete peaks, characteristic of individualized tubes was not observed in the optical data, as the work was done with bundles of tubes in these experiments. The results are in fact consistent with data previously observed by independent groups on nanotube bundles (Krupke et al., J. Phys. Chem. B, 2003, 107, 5667; Huang et al., J. Phys. Chem. B, 2006, 110, 4686). Nonetheless, it is evident that the transitions of the functionalized tubes are broadened and shifted from those of the purified tubes, likely due to a change in tube bundling characteristics upon reaction and to the presence of a silica coating on the tubes (Banerjee et al., J. Am. Chem. Soc, 2004, 126, 2073). The apparent relative enhancement of the absorbance ratio of metallic (>11000 cm⁻¹ region) vs. semiconducting tubes for the functionalized adducts as compared with their non-derivatized adducts has been previously observed and is consistent with a noticeable increase in tube-tube interaction, aggregation, and bundling effects as opposed to any true electronic selectivity associated with the current reaction (Huang et al., J. Phys. Chem. B, 2006, 110, 4686).
Raman spectroscopy characterization: Resonance Raman spectroscopy is a very sensitive probe in determining the structural and electronic properties of carbon nanotubes (Dresselhaus et al., Physics Reports, 2005, 409, 47; Dresselhaus et al., Acc. Chem. Res., 2002, 35, 1070; Rao et al, Science, 1997, 275, 187). The position and intensity of the bands in Raman spectra are strongly dependent upon the laser excitation energy used because different nanotubes with different diameters and chirality (and hence electronic characteristics be they metallic or semiconducting) are in resonance at different excitation energies.

The SWNT Raman spectrum is determined by three main band regions: the radial breathing mode (RBM) (100-350 cm⁻¹), the tangential mode (G-band) (1500-1600 cm⁻¹) and the disorder D mode (1280-1320 cm⁻¹) (Dresselhaus et al., Acc. Chem. Res., 2002, 35, 1070; Rao et al, Science, 1997, 275, 187). The RBM features correspond to coherent vibrations of the carbon atoms in the radial direction and are strongly dependent on the diameter of the tubes. By contrast, the tangential mode is weakly dependent on the diameter of the nanotubes but shows distinctive behavior modes for metallic and semiconducting tubes. It is known that the semiconducting nanotubes have narrow Lorentzians in this region where as metallic nanotubes are characterized by a high frequency Lorentzian coupled to broad low energy Breit-Wigner-Fano (BWF) tails (Yu et al., J. Phys. Chem. B, 2001, 105, 1123). The Fano component in metallic SWNTs essentially arises from the coupling of discrete phonons to an electronic continuum (Brown et al., Phys Rev. B, 2000, 61, 7734). The intensity of the defect or disorder band is a measure of the conversion of sp² to sp³-hybridized carbon in the intrinsic structural frame network of SWNTs. A sizeable increase in the ratio of the disorder D mode to G mode intensity after chemical treatment implies disruption of the electronic band structure of derivatized carbon nanotubes and is a diagnostic for potentially destructive, covalent chemical functionalization of nanotube sidewalls (Bahr et al., J. Mater. Chem., 2002, 12, 1952; Chen et al., J. Phys. Chem. B., 2006, 110, 11624; Dyke et al., J. Am. Chem. Soc., 2003, 125, 1156; Osswald et al., Chem. Mater. 2006, 18, 1525).

In the present study, focus is on the radial breathing modes and the disorder modes observed in the Raman spectra of the samples. In addition, the discussion is also explicitly divided for RBMs into two parts: (1) a comparison between air-oxidized nanotubes and their pristine counterparts as well as (2) a comparison between silane-functionalized nanotubes and air-oxidized nanotubes from whence they were derived.

The radial breathing mode (RBM) frequency, ω_{RBM}, is inversely proportional to the diameter of the nanotubes (dₜ) presented empirically by the following equation:

ω_{RBM}=C₁/dₜ+C₂

with C₁=223.5 (nm cm⁻¹) and C₂=12.5 cm⁻¹, based on studies of individual HiPco nanotubes (Bachile et al., Science, 2002, 560- 361; Strano et al., Nano. Lett, 2003, 3, 1091). RBM bands are also sensitive to the degree of aggregation and bundling of the carbon nanotubes themselves. It has been shown by previous studies that the 266 cm⁻¹ peak at 514.4 and 780 nm excitation and 218 cm⁻¹ peak at 632.8 nm excitation wavelength can provide information about the extent of aggregation (Heller et al., J. Phys. Chem. B, 2004, 108, 6905; Karajanagi et al., Langmuir, 2006, 22, 1392; Hennrich et al., J. Phys. Chem. B, 2005, 109, 10567). All spectra analyzed were normalized at a specific RBM feature. This normalization at specific RBM features allows for the evaluation of the relative intensities of different, varyingly reacted nanotubes present in the different samples. It should be noted that there was no net change in the overall population of nanotubes during either the oxidation or electrochemical functionalization steps. Hence, a loss of nanotubes during these processes was not expected.
Comparison of RBM Features between Air-Xxidized and Pristine HiPco Tubes:

As described earlier, air oxidized nanotubes are generated under a relatively mild oxidation process and the process itself is considered to be a relatively non-destructive means of nanotube purification (Park et al., J. Mater. Chem., 2006, 16, 141). That is, unlike the ozonolysis reaction which substantially disrupts the electronic properties of functionalized nanotubes, air oxidation is not expected to severely disrupt the electronic properties of carbon nanotubes, which is consistent with what was observed from the results in the D band region. Nevertheless, because of effects such as hydrogen bonding, the bundling/aggregation effect of nanotubes will likely influence the shape of the RBM bands of air-oxidized tubes at different excitation wavelengths.

FIG. 8a depicts the RBM modes of Raman spectra at 780 nm excitation. At this laser wavelength, the excitation is primarily resonant with the υ2→c2 transitions of semiconducting nanotubes. The purple line represents the signal due to pristine nanotubes while data in red are associated with their air-oxidized counterparts. The RBM feature at 233 cm⁻¹ corresponds to 1.01 nm diameter tubes and has been assigned to (11,3) semiconducting nanotubes, while the feature at 266 cm⁻¹ has been assigned to either (10,2) or (11,0) nanotubes corresponding to nanotubes possessing a diameter of 0.88 nm (Heller et al., J. Phys. Chem. B, 2004, 108, 6905). A key finding is the considerable increase noted in the intensity of the RBM feature at 266 cm⁻¹ for the air-oxidized nanotubes as compared with their pristine counterparts, an observation consistent with an increase in aggregation or bundling of air-oxidized carbon nanotubes compared to their pristine counterpart (Heller et al., J. Phys. Chem. B, 2004, 108, 6905; Karajanagi et al., Langmuir, 2006, 22, 1392). Without wanting to be limited to a mechanism, this finding is attributed to an increase in intertube interactions for air-oxidized tubes because of an increased propensity for hydrogen bonding among the tubes and tube bundles.

The same trend is also observed at the excitation wavelength of 514.5 cm⁻¹ (FIG. 8b), which brings smaller-diameter metallic as well as larger-diameter semiconducting tubes into resonance (Strano et al., J. Am. Chem. Soc., 2003, 125, 16148.; Krupke et al., Science, 2003, 301, 344; Chattopadhyay et al., J. Am. Chem. Soc, 2003, 125, 3370). The RBM features at 205, 232 and 248 cm⁻¹ have been assigned to (10,7), (10,4) and (12, 0) nanotubes corresponding to tubes measuring 1.15 nm, 1.02 nm and 0.95 nm in diameter, respectively. The feature at 187 cm⁻¹ has been designated by a (16, 0) semiconducting nanotube possessing a diameter of 1.28 nm. Prominent RBM features are localized at 264 cm⁻¹ and 272 cm⁻¹, which can be assigned to (9,3) and (8,5) nanotubes with diameters of 0.88 nm and 0.91 nm, respectively. As was observed previously upon excitation at 780 nm, there is a distinctive increase in the peak intensity at both 264 cm⁻¹ and 272 cm⁻¹ in the spectrum for air-oxidized nanotubes as compared with their pristine counterparts, which can be ascribed to an increase in the aggregation state of air-oxidized carbon nanotubes as compared with their pristine analogues.

Results upon excitation at 633 nm, which probes both the metallic and semiconducting tubes, are shown in FIG. 8c (Hennrich et al., J. Phys. Chem. B, 2005, 109, 10567; Strano et al., Science, 2003, 301, 1519). RBM features at 194 cm⁻¹ and 218 cm⁻¹ have been assigned to the (13,4) and (9,9) metallic tubes corresponding to the diameters 1.21 nm and 1.08 nm, respectively. A set of peaks localized at 256 nm and at 283 nm have been assigned to (10,3), (7,6) and (8,3) nanotubes with diameters ranging from 0.81 nm to 0.93 nm. The peak at 218 cm⁻¹ has been previously attributed to nanotube bundling and was found as expected to be higher in intensity for air-oxidized nanotubes as compared with their pristine counterparts, consistent with the idea of aggregation of the purified tubes (Hennrich et al., J. Phys. Chem. B, 2005, 109, 10567).

Comparison of RBM Features between Air-Oxidized and Silane-Functionalized Nanotubes:

Returning to FIG. 8a, with RBM data at 780 nm excitation, the air oxidized nanotubes, Si-SWNT-1, Si-SWNT-2, and Si-SWNT-ctrl-1 samples are represented by the red, blue, green, and black curves, respectively. The peak positions of the RBM features of the silane-functionalized nanotubes are similar to those of the air-oxidized nanotubes previously discussed. It is noteworthy that in all of the data, any conclusive evidence for either diameter or electronic structure selectivity in the functionalization reaction was not observed. This effect is attributed to the fact that in the condensation reaction reported herein, silica simply coats all nanotubes and nanotube bundles non-discriminately. The intensities of the RBM feature at 266 cm⁻¹ for the Si-SWNT-1 and Si- SWNT-Ctrl-1 samples are essentially identical to those of air-oxidized nanotubes, suggesting that silica merely coated bundles of loosely connected carbon nanotubes within the mat electrode. Aggregation was more pronounced in the Si-SWNT-2 sample, implying a more effective bundling regimen during the functionalization reaction when the nanotubes were suspended and dispersed in solution. Similar trends were noted at both excitation wavelengths of 514 nm and 633 nm, where the corresponding intensities of peaks at 266 and 218 cm⁻¹, respectively, were considerably enhanced for both Si-SWNT-1 and Si-SWNT-2 samples, suggestive of significant silica coating on and therefore, aggregation of bundles of carbon nanotubes.

### D and G Band Analysis

FIG. 9a depicts the Raman spectra of air-oxidized (red) and pristine nanotubes (purple) in the region of 1200-1700 cm⁻¹ upon excitation at 780 nm. Unlike for tubes subjected to ozonolysis wherein it is expected that potentially damaging covalent functionalization occurs upon chemical treatment, in the current study, a significant change in the intensity of the D band upon air oxidation was not observed. (Banerjee et al., J. Phys. Chem. B, 2002, 106, 12144). This conclusion supports the inherent assumption that air oxidation represents a mild protocol for nanotube purification without significant destruction of the electronic band structure of the processed nanotubes. Furthermore, the intensity of the D band also remains relatively unchanged (i.e. unaffected) for silane-functionalized tubes (Si-SWNT-1 and Si-SWNT-2) as well as for the control samples. This piece of evidence, taken in context with the other results, provides strong corroboration that the silica electrodeposition reaction is a non-covalent one; the lack of a strong D band signal suggests the absence of covalent functionalization of the carbon nanotube sidewalls. In other words, the electronic structure of the sidewalls is barely affected by the electrodeposition reaction. The work therefore provides experimental justification for the theoretical assertion that a non-bonded, protective layer of silica only weakly perturbs the electronic structure of single walled carbon nanotubes (SWNTs) (Wojdel et al., J. Phys. Chem. B, 2005, 109, 1387). Data at 632.8 nm (FIG. 9b) are consistent with this picture and show similar behavior, i.e. minimal alteration in the D band intensity for functionalized as compared with pristine samples.

FIG. 9c shows the Raman spectra at 514.5 nm excitation wavelength. At 514.5 nm, the pristine nanotubes have a large Fano component since mostly metallic tubes are brought into resonance at this wavelength. There was some broadening of the Fano lineshape as one progressed from pristine to air-oxidized to silane-derivatized tubes; it has been reported that Fano features are sensitive to changes in the state of aggregation upon functionalization (Banerjee et al., Nano Lett., 2004, 4, 1445). The most critical observation remains though that no significant change in the D band intensity was observed for air-oxidized tubes as compared with their pristine counterparts, implying the electronically non-destructive nature of the electrodeposition protocols.

Comparison between Methods of Electrodeposition

Different procedures by which SWNTs can be coated with a controllable thickness of silica film, depending on the magnitude of the potential, concentration, and time of deposition, have been demonstrated. There seem to be a number of advantages and relatively minor accompanying disadvantages associated with each procedure.

In the first procedure, SWNT mat electrodes were reproducibly prepared using a known density of SWNTs in each case. The main advantage of this methodology is that SWNTs could be directly used as the working electrode for silica deposition. An additional advantage is that the reduction process involving oxygen appeared around −300 mV, occurring at a much less negative value as compared with what would have been expected using either a Pt, glassy carbon, or ITO electrode (Deepa et al., Anal. Chem., 2003, 75, 5399; Shacham et al., Adv. Mater., 1999, 11, 384). Thirdly, the thickness of this coating could be carefully fine tuned by judicious variation of a wide range of potentials and concentrations of the sol solution.

The carbon nanotube mat electrode can be visualized as a porous entity in which carbon nanotubes are entangled with each other within a gap-filled mesh; not surprisingly, these types of mat electrodes are mechanically fragile. When the carbon nanotube mat electrode is thin, either individual nanotubes or small bundles of the nanotube will have maximal exposure to the sol solution for silica deposition to occur on the largest number of SWNTs. Nonetheless, the methodology is also conducive to the formation of silica on more robust, thicker free-standing carbon nanotube films. However, in these latter systems, produced from thicker densities of nanotubes measuring 1000 μg/cm², there is a tendency that only the outermost layers of nanotubes are coated with silica and that to functionalize the interior of the nanotube would require potentially destructive sonication (and accompanying cracking) of the film.

In the second procedure, nanotubes have been dispersed in a sol solution and electrodeposition was carried out using a platinum working electrode. As indicated previously, a localized pH change in the vicinity of the Pt electrode will result in the base-catalyzed condensation of the sol and subsequent deposition of silica onto the carbon nanotube surface. It is recognized that this is an indirect method for coating carbon nanotubes with silica in that the thickness of silica coating will depend on the physical distance of the dispersed carbon nanotubes themselves from the working electrode. However, this possible limitation has been overcome by minimizing and thereby optimizing the amount of sol solution and concentrations used, as well as by rapid and continuous stirring during the electrodeposition process to ensure a more homogeneous coating of silica on the carbon nanotubes.

In summary, it has been demonstrated for the first time that carbon nanotubes can be coated with a stable and reproducible film of controllable thickness using a reasonably simplistic protocol. The methodology developed has several advantages over other previously reported techniques in that the thickness of the resultant silica film can be controlled rather easily by rationally varying reaction parameters such as potential and current, as well as reaction time and sol concentration. This level of control allows for these functionalized tubes to be used in a variety of electronics and optics applications.

It has been demonstrated by Raman, UV-visible-near-IR, XPS, and other spectroscopic techniques that silica is not covalently attached to the carbon nanotube, but is rather noncovalently bound to the tubes through van der Waals interactions. This is a significant finding because covalent attachment of functional moieties onto carbon nanotube surfaces may destroy their desirable electronic properties. More generally, this electrochemical technique is mild, non-destructive, and environmentally friendly in that it requires minimal amounts of reactants and reaction steps. Moreover, it can operate under either aqueous or mildly ethanolic reaction conditions, without the need for either harsh acidic or basic conditions, and moreover, this procedure can be carried out at ambient temperature and pressure conditions under relatively rapid reaction times. This methodology is important for a number of practical reasons including (a) the ability to biocompatibilize carbon nanotubes through the silica coating, rendering these materials useful for a wide range of biological applications, (b) the generation of carbon nanotubes with high resistance to oxidation, and (c) the generalization of this technique to other oxide materials thereby creating the potential for functional nanocomposites.

### Supporting Information Available

The following supplementary information is available free of charge via the Internet at http://pubs.acs.org: (i) Description of mechanism of base-catalyzed hydrolysis and associated sol-gel reaction used in electrodeposition procedures. (ii) SEM image and the corresponding EDS spectrum of carbon nanotubes deposited on a platinum foil electrode along with silica. (iii) AFM height images of silica-coated nanotubes synthesized by electrochemical deposition of carbon nanotubes dispersed in the solution. (iv) Additional HRTEM images of nanotubes electrodeposited with Si. (v) SEM image and corresponding EDS spectrum of a control sample. (vi) High-resolution XPS spectra of purified single-walled carbon nanotubes. (vii) High-resolution XPS spectra of a control sample. (viii) High-resolution XPS spectra of silica-coated nanotubes.

1. A method of controlling the rate of noncovalent silica deposition onto at least one carbon nanotube, the method comprising:
(a) providing a one chamber electrochemical cell comprising a working electrode comprising at least one carbon nanotube; a reference electrode; a counter electrode; supporting electrolytes; and a reagent solution, wherein the reagent solution comprises a precursor of silica; and
(b) applying a selected negative potential to the working electrode, wherein the rate of silica deposition onto the at least one carbon nanotube increases as the potential becomes more negative.

2. The method of claim 1 wherein the working electrode is a SWNT mat or a single SWNT or a plurality of individualized SWNTs.

3. The method of claim 1 wherein the reference electrode is a silver/silver salt wire or a Saturated Calomel Electrode (SCE).

4. The method of claim 3 wherein the reference electrode is an Ag/AgCl wire, Ag/AgNO₃ wire or an Ag/Ag₂SO₄ wire.

5. The method of claim 1 wherein the counter electrode is a Pt electrode or a glassy carbon electrode.

6. The method of claim 1 wherein the precursor of silica comprises tetramethoxysilane (TMOS), tetraethylorthosilicate or methyltrimethoxysilane (MTMOS).

7. The method of claim 1 wherein the precursor of silica comprises {2-[2-(2-methoxyethoxy)ethoxy]ethoxy}trimethylsilane, bis{2-[2-(2-methoxyethoxy)ethoxy]ethoxy}dimethylsilane, {3-[2-(2-(2-methoxyethoxy)ethoxy)ethoxy]-propyl}trimethylsilane, {[2-(2-(2-methoxyethoxy)ethoxy)ethoxy]-methyl}trimethylsilane.
3-(Glycidoxypropyl)trimethoxysilane (GPTMS), N-(2-aminoethyl)-3-aminopropyl-trimethoxysilane, or dimethyldichlorosilane.

8. The method of claim 1 further comprising controlling the rate of noncovalent silica deposition by varying the concentration of the precursor of silica, wherein as the precursor of silica concentration is increased, the rate increases.

9. The method of claim 1 further comprising stirring the reagent solution whereby the degree of uniformity of silica deposition is increased.

10. The method of claim 2 further comprising immersing the SWNT mat in an aqueous solvent after silica deposition to debundle SWNTs from the mat.

11. The method according to claim 1 wherein the potential of the working electrode is varied in the range from about −300 mV to about −1000 mV as compared to the reference electrode.

12. A carbon nanotube with a noncovalently attached silica coating formed by the method comprising:
(a) providing a one chamber electrochemical cell comprising a working electrode comprising at least one carbon nanotube; a reference electrode; a counter electrode; supporting electrolytes; and a reagent solution, wherein the reagent solution comprises a precursor of silica; and
(b) applying a selected negative potential to the working electrode, wherein the rate of silica deposition onto the at least one carbon nanotube increases as the potential becomes more negative.

13. A method of controlling the rate of silica deposition onto carbon nanotubes, the method comprising:
(a) placing a sonicated nanotube dispersion and a working electrode into a silica precursor sol; and
(b) applying a selected negative potential to the working electrode, wherein the rate of silica deposition onto the nanotubes in the dispersion increases as the potential becomes more negative,
wherein the sol comprises an electrolyte placed in an aqueous solution of a silica precursor.

14. The method of claim 13 wherein the working electrode is Pt, indium-tin-oxide (ITO) or a glassy carbon electrode.

15. The method of claim 13 wherein the silica precursor comprises tetramethoxysilane (TMOS), tetraethylorthosilicate or methyltrimethoxysilane (MTMOS).

16. The method of claim 13 wherein the silica precursor comprises {2-[2-(2-methoxyethoxy)ethoxy]ethoxy}trimethylsilane, bis{2-[2-(2-methoxyethoxy)ethoxy]ethoxy}dimethylsilane, {3- [2-(2-(2-methoxyethoxy)ethoxy)ethoxy]-propyl}trimethylsilane, {[2-(2-(2-methoxyethoxy)ethoxy)ethoxy]-methyl}trimethylsilane. 3-(Glycidoxypropyl)trimethoxysilane (GPTMS), N-(2-aminoethyl)-3-aminopropyl-trimethoxysilane, or dimethyldichlorosilane.

17. The method of claim 13 further comprising controlling the rate of noncovalent silica deposition by varying the concentration of the silica precursor, wherein as the silica precursor concentration is increased, the rate increases.

18. The method of claim 13 further comprising stirring the reagent solution whereby the degree of uniformity of silica deposition is increased.

19. The method according to claim 13 wherein the potential of the working electrode is varied in the range from about −700 mV to about −1000 mV.

20. A carbon nanotube with a noncovalently attached silica coating formed by the method comprising:
(a) placing a sonicated nanotube dispersion and a working electrode into a silica precursor sol; and
(b) applying a selected negative potential to the working electrode, wherein the rate of silica deposition onto the nanotubes in the dispersion increases as the potential becomes more negative,
wherein the sol comprises an electrolyte placed in an aqueous solution of silica precursor.
